(19) United States
(12) Patent Application Publication
(10) Pub. No.: US 2002/0091849 A1
(43) Pub. Date: Jul. 11, 2002

(54) Device and method for transmitting A/V data in network

(76) Inventor: Junhyeok Heo, Daejeon-city (KR)

Correspondence Address: DUANE MORRIS LLP, 100 COLLEGE ROAD WEST, SUITE 100, PRINCETON, NJ, 08540-6604, US

(21) Appl. No.: 10/008,316

(22) Filed: Nov. 3, 2001

(30) Foreign Application Priority Data
Nov. 13, 2000 (KR) 2000-67127

(51) Int. Cl. G06F 15/16

(52) U.S. Cl. 709/231

(57) ABSTRACT

The present invention discloses a device for transmitting an audio and video (A/V) data in network, comprising a coder/transmission buffer coding and storing the A/V data, inputted from each of channels within a server providing the A/V data of one channel or multi channels for users connected to the network, to proper size fitting to the network states, and a user transmission controller transmitting a coded storing data on the coder/transmission buffer to the user, wherein the users are grouped with the user transmission controllers transmitting the coded data according to the network state of the group, while each of the user transmission controllers is allocated to each of the users connected to the server. The present invention also discloses a method for transmitting an audio and video (A/V) data in network, comprising a step of transmitting the A/V data of one channel or multi channel to the coder and the transmission buffer, a step of coding and storing the A/V data transmitted to the coder and the transmission buffer, and a step of transmitting the coded storing data to each of the users connected to the network through the grouped user transmission controller. Therefore, the present invention provides the user for one of the most optimized services without large loads to the server system, even though the number of the users is rapidly increased. It can be accomplished by grouping each of the users, according to the network states, to code the A/V data to generate proper size of the data. Therefore, it is not necessary that each of the users prepares a coder and a transmission buffer within the server respectively, wherein the server is connected to numerous users through the network to provide the A/V data of one or multi-channel.

### CROSS REFERENCE

This application claims the benefit of Korean Patent Application No. 2000-67127, filed on Nov. 13, 2000, under 35 U.S.C. § 119, the entirety of which is hereby incorporated by reference.

### BACKGROUND OF THE INVENTION

1. Field of the Invention

The present invention refers to a device and method for transmitting an audio and video (A/V) data in network and more particularly, a device and method for transmitting A/V data properly through network without large loads to a server. In this case, the server provides A/V data of one channel or multi-channel for numerous users, even though the numbers of users connecting to the server are increased, especially in an Internet or a VOD (video on demand) broadcast.

2. Description of the Related Art

The users should receive the A/V data through the network because the users are physically remote from the server providing the A/V data in some situations. For such situations, Network Working Group has established RTP (real time protocol) as a standard for transmitting the multi-media data, like A/V data, efficiently through the network.

In the situations of providing the multi-media data by the RTP protocol, the server transmits the multi-media data to each of the users without checking the network states of each of the users, for example without checking data transmission speed such as 56 k, 200 k or 300 k. Instead, separate translators do such checking as shown in FIG. 1. In other words, a translator 3 decodes the A/V data transmitted from the server 1 and decodes the transmitted A/V data again according to the network states of each of the users 2, besides the server 1 for transmitting the A/V data from the multi-media devices to the users 2 on the network.

Such a transmission method requires physical independent translator 3 to be on the network from the server 1 to each of the users 2 besides the server 1, which is non-efficient way in the aspect of expenses and management.

In more, there is another transmission method that the server deals with data transmission directly by checking the network states, which is different from the above described transmission method. In this case, the server transmits the data, after the server codes the data in various ways to reduce the size of the data transmittable through the network, and each of the users receiving the coded data decodes the data again.

There is a difference among the network states from the server to each of the users, for example speed, bandwidth, and stability in the network. Therefore, it is preferable to adjust the size of the coded data transmittable through the network to fit on the network states of each of the users.

Accordingly, as illustrated in FIG. 2, there are coders/transmission buffers (1˜n) that correspond to the numbers of the user transmission controllers (1˜n) within the server 1 respectively, while the server 1 provides the A/V data for the users connected on the network. The coders/transmission buffers (1˜n) codes and stores the A/V data, which is proper sizes to the network states, inputted from each of the channels (1˜m).

However, the above described method requires the number of coders/transmission buffers (1˜n) to be increased as many as the number of the channels (m)×the number of the users (n), as the numbers of the users connected to the server 1 are increased, in other words the connected users (n) are increased. Therefore, the above described method does not provide proper transmission service for the users because of too large loads to the server.

### SUMMARY OF THE INVENTION

To overcome the above described problems, preferred embodiments of the present invention provide a method for dividing numerous users into groups in the server properly, as considering the network states of each of the numerous users to have the similar network states to the users in a group. In the above case, the server transmits the A/V data of one channel or multi-channel to the numerous users. Additionally, the method provides coders/transmission buffers as many as the number of the divided groups, and generates proper sizes of data according to the divided groups for transmitting the data to the numerous users without large loads to the server. In other words, when the number of channels is m and the number of the groups is k, the number of coders/transmission buffers is as many as the number of channels (m) by the number of groups (k), which will be enough to transmit the data regardless the number of the users.

In order to achieve the above object, the preferred embodiments of the present invention provide an A/V data transmission device comprising coders/transmission buffers and user transmission controllers. The coders/transmission buffers code/store the A/V data inputted from each of the channels in proper sizes for fitting on the network states within the server, while the server provides the A/V data of one channel or multi-channel for the users connected to the network. The user transmission controllers transmit each of the coded storing data in the coders/transmission buffers to the users.

In this case, the A/V data transmission device allocates a user transmission controller to each user connected to the server and groups the user transmission controllers, wherein each of the groups of the user transmission controllers has a coder/transmission buffer respectively, and transmits the coded data according to the network states.

Another preferred embodiment of the present invention provides a method comprising a step of transmitting the A/V data of one channel or multi-channel to the coder/transmission buffer within the server, a step of coding and storing the A/V data transmitted from the coder/transmission buffer of the previous step, and a step of transmitting the coded store data of the previous step to the users connected to the network via the grouped user transmission controllers.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a block diagram of an A/V data transmission device through a translator in the conventional network;

FIG. 2 is a block diagram of the A/V data transmission device through a conventional server on network;

FIG. 3 is a block diagram of the A/V data transmission device through the server on the network according to the preferred embodiment of the present invention;

FIG. 4 is a flow chart of the A/V data transmission method in the network of the preferred embodiment according to the present invention;

FIG. 5 is a flow chart of a coder for generating a frame data by coding the data of the preferred embodiment according to the present invention;

FIG. 5a is a flow chart of the coder for deciding whether it is necessary to code new frame data or not, according to the preferred embodiment of the present invention;

FIG. 5b is a flow chart of the coder when the coder codes frame data discriminately into key frame data and reference frame data, according to the preferred embodiment of the present invention;

FIG. 5c is a flow chart illustrating an example for deciding whether it is necessary to code the new frame data or not in FIG. 5b;

FIG. 5d is a flow chart illustrating an example for employing Condition 5 in FIG. 5b;

FIG. 5e is a flow chart illustrating an example for employing Condition 5 in FIG. 5c;

FIG. 6 is a detail flow chart for deciding whether it is necessary to code the new frame data or not, according to the preferred embodiment of the present invention;

FIG. 6a is a flow chart illustrating an example for coding frame data discriminately into the key frame data and the reference frame data in FIG. 6;

FIG. 6b is a flow chart illustrating an example employing Condition 2 for deciding whether it is necessary to code the new frame data or not, according to the preferred embodiment of the present invention;

FIG. 6c is a flow chart illustrating an example for coding frame data discriminately into the key frame data and the reference frame in FIG. 6b;

FIG. 7 is a detail flow chart for storing the new frame data to a transmission buffer of the preferred embodiment according to the present invention;

FIG. 7a is a flow chart illustrating an example for storing frame data to the transmission buffer by employing Condition 4 of the preferred embodiment according to the present invention;

FIG. 8 is a flow chart illustrating a user transmission controller transmitting frame data to each of the users, according to the preferred embodiment of the present invention;

FIG. 8a is a flow chart illustrating an example of the user transmission controller employing Consideration 5 of the preferred embodiment according to the present invention;

FIG. 8b is a flow chart illustrating an example of the user transmission controller employing Consideration 1 or Consideration 2 in FIG. 8;

FIG. 8c is a flow chart illustrating an example of the user transmission controller employing Consideration 1 or Consideration 2 in FIG. 8a additionally;

FIG. 8d is a flow chart illustrating an example of the user transmission controller employing Consideration 4 in FIG. 8 additionally;

FIG. 8e is a flow chart illustrating an example of the user transmission controller employing Consideration 4 in FIG. 8a additionally;

FIG. 8f is a flow chart illustrating an example of the user transmission controller employing Consideration 4 in FIG. 8b additionally;

FIG. 8g is a flow chart illustrating an example of the user transmission controller employing Consideration 4 in FIG. 8c additionally;

FIG. 9 is a detail flow chart for deciding whether the next transmittable frame data is in the user transmission buffer or not, according to the preferred embodiment of the present invention;

FIG. 9a is a flow chart illustrating an example employing multi-channels for deciding whether the next transmittable frame data is in the user transmission controller or not, according to the preferred embodiment of the present invention;

FIG. 9b is a flow chart illustrating an example employing Consideration 3 for deciding whether the next transmittable frame data is in the user transmission controller or not, according to the preferred embodiment of the present invention;

FIG. 9c is a flow chart illustrating an example employing Condition 2 for deciding whether the next transmittable frame data is in the user transmission controller or not, according to the preferred embodiment of the present invention;

FIG. 10 is a detail flow chart for deciding whether the transmittable frame data is in the user transmission buffer or not, when a channel and a user are determined, according to the preferred embodiment of the present invention;

FIG. 10a is a flow chart illustrating an example employing Consideration 6 for deciding whether the transmittable frame data is in the user transmission buffer or not, when a channel and a user are determined, according to the preferred embodiment of the present invention;

FIG. 10b is a flow chart illustrating an example employing Condition 1 for deciding whether the transmittable frame data is in the user transmission buffer or not, when a channel and a user are determined, according to the preferred embodiment of the present invention;

FIG. 10c is a flow chart illustrating an example employing Consideration 6 and Condition 1 for deciding whether the transmittable frame data is in the user transmission buffer or not, when a channel and a user are determined, according to the preferred embodiment of the present invention;

FIG. 10d is a flow chart illustrating an example employing Condition 3 for deciding whether the transmittable frame data is in the user transmission buffer or not, when a channel and a user are determined, according to the preferred embodiment of the present invention;

FIG. 10e is a flow chart illustrating an example employing Consideration 6 and Condition 3 for deciding whether the transmittable frame data is in the user transmission buffer or not, when a channel and a user are determined, according to the preferred embodiment of the present invention;

FIG. 10f is a flow chart illustrating an example employing Condition 1 and Condition 3 for deciding whether the transmittable frame data is in the user transmission buffer or not, when a channel and a user are determined, according to the preferred embodiment of the present invention; and

FIG. 10g is a flow chart illustrating an example employing Consideration 6, Condition 1 and Condition 3 together for deciding whether the transmittable frame data is in the user transmission buffer or not, when a channel and a user are determined, according to the preferred embodiment of the present invention.

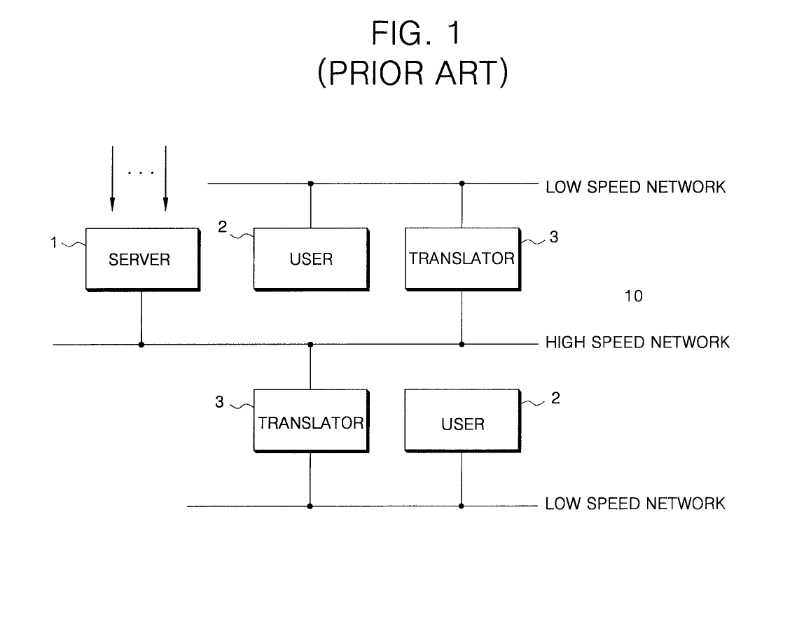

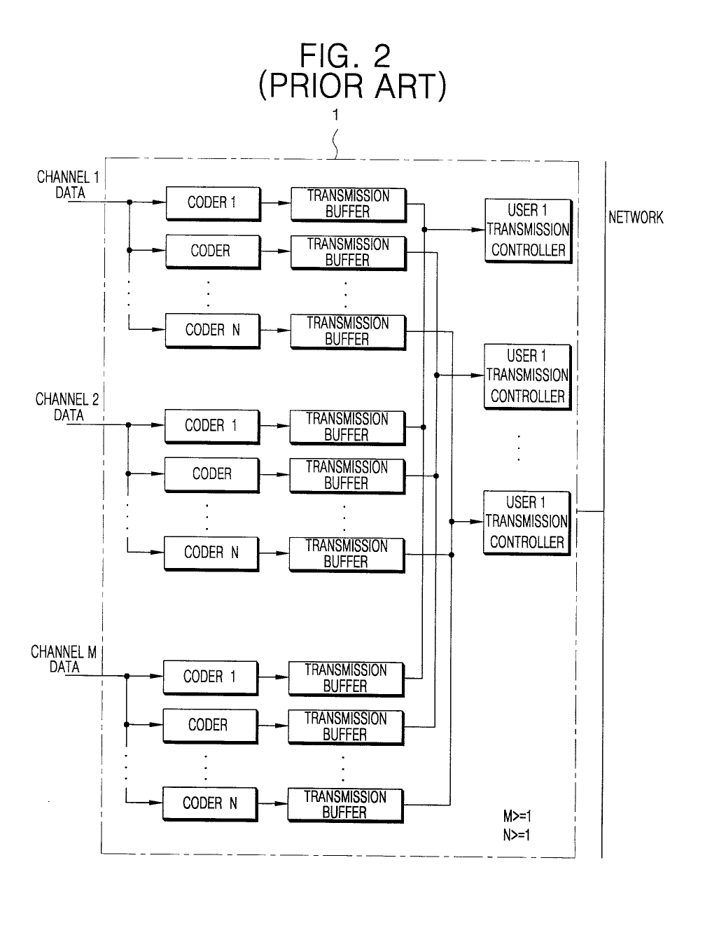

### DETAILED DESCRIPTION OF PREFFERED EMBODIMENTS

To accomplish the purpose of the present invention, the present invention provides a device for transmitting an audio and video (A/V) data in network, comprising coder/transmission buffers and user transmission controllers, wherein users are grouped with the user transmission controllers transmitting the coded data according to the network state of the group, while each of the user transmission controllers is allocated to each of the users connected to the server.

The coder/transmission buffer codes and stores the A/V data, inputted from each of channels within a server providing the A/V data of one channel or multi channels for users connected to the network, to proper size fitting to the network states. The user transmission controller transmits a coded storing data on the coder/transmission buffer to the user.

In more, one group of the user transmission controllers according to the present invention comprises one coder and one transmission buffer.

To accomplish the purpose of the present invention, the present invention provides a method for transmitting an audio and video (A/V) data in network, comprising a step of transmitting the A/V data of one channel or multi channel to the coder and the transmission buffer, a step of coding and storing the A/V data transmitted to the coder and the transmission buffer, and a step of transmitting the coded storing data to each of the users connected to the network through the grouped user transmission controller.

According to the present invention, the step of coding and storing the A/V data and the step of storing the coded data to the transmission buffer are performed in repeats.

According to the present invention, the step of coding the A/V data encodes new data after checking the transmission buffer to avoid unnecessary encoding for the data.

According to the present invention, the step of coding the A/V data comprises a step of deciding whether it is necessary to have the key frame data or not, and a step of coding the data to the key frame data or to the reference frame data according to the decision.

According to the present invention, the method further comprises a step of checking whether ‘s’ numbers of the reference frame data are encoded continuously after encoding the reference frame data, and a step of memorizing to generate the key frame data in the case that the ‘s’ numbers of the reference frame data are continuously encoded.

According to the present invention, the step of deciding whether it is necessary to encode new data or not, is decided by whether the last generated frame data is transmitted or not.

According to the present invention, the step of deciding whether it is necessary to encode new data or not, comprises a step of deciding whether it is necessary to encode the key frame data or not, and a step of deciding whether the last generated frame data is transmitted or not.

According to the present invention, the step of deciding whether it is necessary to encode new data or not, comprises a step of deciding the network states, and a step of deciding whether at least one of the last generated ‘n’ frame data is transmitted or being transmitted to one of the users or not in the case that the network state is good.

According to the present invention, the step of deciding whether it is necessary to encode new data or not, comprises a step of deciding whether the key frame data is necessary or not, a step of deciding whether the network transmission speed is fast enough in the case that the key frame data is not necessary, a step of deciding whether at least one of the last generated ‘n’ frame data is transmitted or being transmitted to one of the users or not in the case that the network transmission speed is fast enough, and a step of deciding whether the last generated frame data is transmitted or not in the case that the network transmission speed is not fast.

According to the present invention, the step of coding and storing the A/V data transmitted to the coder and the transmission buffer comprises a step of calculating a size of an added frame data to the transmission buffer, a step of checking an employing area on the transmission buffer for the added frame data, a step of storing the frame data to the employing area on the transmission buffer.

According to the present invention, the step of storing the frame data to the transmission buffer comprises a step of deciding whether there is another frame data in the employed area and this will-be corrupted frame data is being transmitted too any user or not, a step of deciding whether the key frame data is in the transmission buffer or not in the case that the will-be corrupted frame data is being transmitted, a step of memorizing to encode the key frame data in next time in the case that the key frame data is not, and a step of storing the memorized key frame data to the transmission buffer.

According to the present invention, the step of transmitting the coded storing data to each of the users connected to the network through the grouped user transmission controller comprises a step of initializing the user transmission controller, a step of deciding whether next frame data transmitable to the users is or not, a step of copying the frame data from the transmission buffer to additional memory in the case that the next frame data transmitable to the user is in the transmission buffer, a step of transmitting the copied data to the users, and a step of deciding whether the network is connected or not after transmitting the data.

According to the present invention, the step of transmitting the coded storing data to each of the users connected to the network through the grouped user transmission controller comprises a step of initializing the user transmission controller, a step of deciding whether the next frame data transmitable to the users is or not, a step of checking the area of the transmission buffer of the next transmitable frame data instead of copying the frame data to an additional memory to reduce memory usage according to an increase of the in the case that the frame data transmitable to the user is in the transmission buffer, a step of transmitting the frame data on the area of the transmission buffer, a step of deciding whether the frame data area is re-employed by another frame data while transmission, a step of reporting to the user that the previous transmitted data is a wrong data, in the case that the frame data area is re-employed, and a step of deciding whether the network is connected or not.

According to the present invention, the step of transmitting the frame data comprises a step of reporting the beginning of the usage, and a step of reporting the completion of the usage.

According to the present invention, the method further comprises a step of automatically changing the present group to a proper group considering network states in the case that the network is connected

According to the present invention, the step of deciding whether the next frame data transmitable to the users is in the transmission buffer comprises a step of deciding whether the next frame data transmitable to the users is in the transmission buffer of a specified channel or not

According to the present invention, a step of deciding whether the next transmitable frame data is in the transmission buffer in the case of multi channel comprises a step of selecting the channel ‘i’ as the next checking channel with having the reference of the transmitted channel or the inquired channel basically, a step of deciding whether the device checks all channels from the selected channel ‘i’ or not, a step of deciding whether the channel ‘i’ is served to the users in the case that the device does not treat all channels from the selected channel ‘i’ or not, a step of selecting the channel ‘i’ by deciding whether the next frame data transmitable to the users is in the transmission buffer of the channel in the case that the channel is served to the users or not.

According to the present invention, in the case that the oldest generated channel is transmitted at first by considering the synchronism between the channels, the method further comprises a step of deciding whether the transmitable channel is fixed after the device completes to check all channel or not, and a step of deciding whether the generation time of the channel ‘i’ is older than the generation time of another channels or not after deciding whether the frame data transmitable to the users is in the transmission buffer of the channel.

According to the present invention, the method further comprises a step of deciding whether the difference between the generation time of the frame data and the present time is less than a predetermined time T to fit on synchronism between the channels more or not, and a step of memorizing to generate the key frame data in next time in the case that the difference between them is not less than the predetermined time T.

According to the present invention, the step of deciding whether the next frame data transmitable to the users is in the transmission buffer comprises a step of deciding in detail whether it is the initial transmission or not in the case that the transmittable channel is fixed, a step of deciding whether the transmission buffer is empty or not in the case of the initial transmission, a step of selecting any one of the frame data on the transmission buffer as the transmitable frame data in the case that the transmission buffer is not empty, while there is no transmitable frame data in the case that the transmission buffer is empty, a step of deciding whether the next transmitable frame data is prepared using the information of the frame data transmitted to the user previously in the case that it is not the initial transmission, and a step of transmitting the next frame data in the case that the next transmitable frame data is prepared, while there is no the next transmitable frame data in the case that the next transmitable frame data is not prepared.

According to the present invention, the step of deciding whether the next frame data transmitable to the user is in the transmission buffer or not comprises, a step of checking whether the next transmitable frame data is in the transmission buffer using the information of the frame data previously transmitted to the user in the case that the key frame data and the reference frame data is not discriminately coded and the transmitable channel is fixed, a step of checking there is a frame data generated later than the next transmitted frame data in the case that the next transmitted frame data is prepared, a step of selecting the last generated frame data as the next transmittable frame data in the case that there is frame data generated later than the next transmitted frame data, a step of deciding whether a key frame data is generated later than the key frame data transmitted to the user recently in the case that the key frame data and the reference frame data is discriminately coded or not, and a step of selecting the last generated key frame data as the next frame data in the case that a more recently generated key frame data is.

According to the present invention, the step of deciding whether the next frame data transmitable to the users is in the transmission buffer or not comprises a step of deciding whether it is the initial transmission state for the users or not, a step of deciding whether there is the key frame data in the initial transmission, and a step of memorizing to generate a key frame data in the case that there is no key frame data.

According to the present invention, the step of deciding whether the next frame data transmitable to the user is in the transmission buffer or not comprises a step of deciding whether the area of the transmission buffer of the frame data transmitted previously in the transmission buffer is re-employed or not when the transmitable channel is fixed, the transmitable frame data on the transmission buffer is transmitted without copying the transmitable frame data from the transmission buffer to the additional memory, to reduce the memory usage according to the increase of the users,

a step of deciding whether a key frame data is generated later than the key frame data transmitted to the users previously in the case that the key frame data and the reference frame data are discriminately coded, or changing the state into the initial transmission states in the case that the key frame data and the reference frame data are not discriminately coded and the area of the transmission buffer is re-employed, a step of memorizing to generate a key frame data by the coder in the case that there is no last generated key frame data recently, and a step of determining the next transmitable frame data in the case that there is the last generated key frame data recently.

Reference will now be made in detail to preferred embodiments of the present invention, example of which is illustrated in the accompanying drawings.

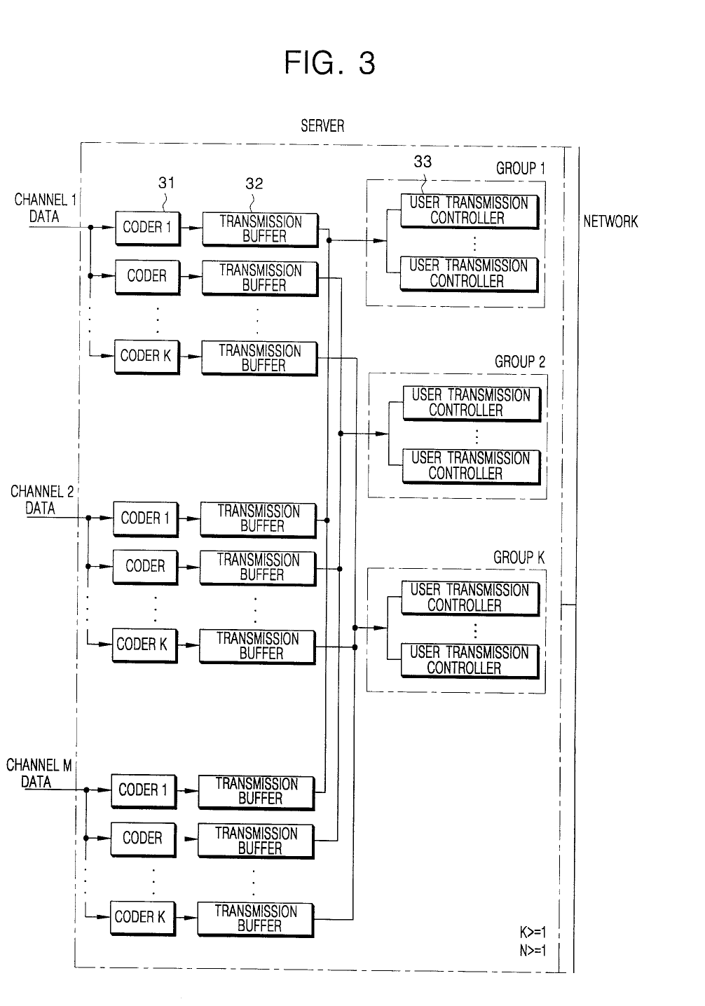

FIG. 3 is a block diagram of the A/V data transmission device in the server on the network of the preferred embodiment according to the present invention. The A/V data transmission device comprises a server 30, a coder 31 and a transmission buffer 32, and a user transmission controller 33. The server 30 provides the A/V data for the users connected to the network. The coder 31 and the transmission buffer 32 code/store the A/V data inputted from each channel in the server 30 in sizes suitable for the network states. A user transmission controller connected to the coder 31 and the transmission buffer 32 is allocated to each user and grouped, according to the network states, and transmits the coded data.

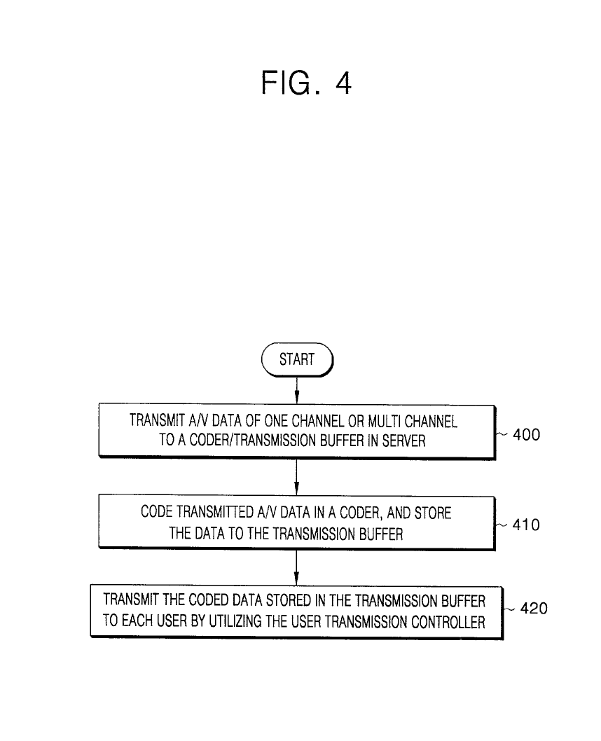

FIG. 4 is a flow chart of the A/V data transmission method in the network of the preferred embodiment according to the present invention. The A/V data transmission method comprises a step (400) for transmitting the A/V data of one channel or multi-channel to the coder 31 and to the transmission buffer 32, a step (410) for coding and storing the A/V data in the coder/transmission buffer (31 and 32), and a step (420) for transmitting the coded storing data in the step (410) to each of the users connected to the network via the grouped user transmission controller.

The present invention like the above described statement codes the A/V data of one channel or multi-channel in frame unit after the A/V data is transmitted to the coder/transmission buffer (31 and 32) in the server 30.

In other words, the frame is a unit for dividing the coded input data, and the frame data is coded to two types. One is a coded key frame data and the other is a coded reference frame data.

While the key frame data can be directly decoded without any other information, the reference frame data can be only decoded with the help of the other frame data. The frame data indicated the coded data in the following statements.

The following will be checked when a data of one channel or multi-channel is transmitted to the users, after grouping the user transmission controller 33, and allocating a coder/transmission buffer (31 and 32) to each group.

<Consideration 1> The coder only codes the input data in the condition that there is no more data transmittable to the users.

<Consideration 2> The network states are checked while applying the condition of Consideration 1 so that some more frame data are pre-encoded in the condition that the network states is good for the overall performance.

<Consideration 3> The generation time of frame data among channels should not be much different from one another in the condition that the device treats the multi-channel data and the synchronism among channels such as a live broadcast is important.

<Consideration 4> After dividing the transmission group according to the network states, groups are automatically re-organized in the case that the network states changes.

<Consideration 5> without preparing additional storing space for the frame data transmitable to the users, and with utilizing the transmission buffer 32 prepared for each of the groups, the memory usage of the device are decreased.

<Consideration 6> The latest frame data is sent to the users in the case that the transmission buffer 32 has more than one frame data transmittable to the users.

A device can apply one or several Considerations among the above described Considerations 1˜6

In the case that the frame data is transmitted to many users in a group by utilizing one coder/transmission buffer (31 and 32) for each of the groups, generating the proper key frame is important by checking numerous situations in each of the users.

The reason of the above description is that the key frame data is relatively larger than the reference frame data, and generating the minimized number of key frame data is preferable to decrease the sizes of the transmittable data through network.

Of course, all the frame data can be encoded into the key frame data and transmitted because the reference frame data requires the other frame data for being decoded.

The present invention generates the key frame data in the following condition.

<Condition 1> The key frame data is generated in the case that a predetermined channel does not have any proper transmittable key frame data, in the case that a new user connects to the network or the connected user changes the served channel into another new channel.

<Condition 2> When Consideration 3 is applied, such as the device treats multi-channel data and the synchronism among channels is important, the key frame data is generated in the case that the difference between the data generation time and the present time is longer than a predetermined time.

<Condition 3> When the new frame data re-employs the frame data area transmitted to the user on a predetermined size of the transmission buffer, and thereon, there is no key frame data generated after the transmitted frame data to the user is generated, a new key frame data is generated.

<Condition 4> When Consideration 5 is applied such as the new frame data re-employs the frame data area transmitted to the user on a predetermined size of the transmission buffer, and thereon, there is no key frame data generated after the transmitted frame data to the user is generated, a new frame data is generated.

<Condition 5> As the key frame data is utilized valuably in decoding, a new key frame data is generated every after the maximum predetermined number of reference frame data is generated.

A device can apply one or several Conditions among the above described Conditions 1˜5 selectively.

The group organization of the user transmission controller 33 can be accomplished in several ways.

<Method 1—Manual selection>

A user connected to the network selects a group according to the network states. In other words, the user recognizes the network states of his own and thereof selects a proper group among the prearranged groups when the user connects to the server.

<Method 2—Fixation after automatic selection>

After a device checks the network states to the user and allocates the user to a proper group when the user connects to the server, the user keeps in the group until the disconnection to the user happens.

<Method 3—Change after automatic selection>

After a device checks the network states to the user and allocates the user to a proper group when the user connects to the server, the user is dynamically moved to any proper group, as the device checks the network states to the user continuously.

In more, there are a direct method and an indirect method for deciding better or worse network states by checking the network states.

<Network checking method 1—Direct method>

Good or bad in network states are checked directly by the bandwidth describing average amounts of transmitted data in a second or by the latency describing average time in a transmission.

<Network checking method 1—Indirect method>

There is a phenomena that the key frame data is frequently requested when the network states of a user is worse than those of any other users and conditions, such as Condition 2, Condition 3, and Condition 4, among the key frame generation conditions occur. Therefore, the network states can be checked indirectly.

The users can check the network states to select group by combing one or several checking methods, and finally gets values illustrating the network states in each of the users. Those values illustrate the network in good states proportionally or reciprocally proportionally.

Each of the groups has the maximum value and the minimum value illustrating the network states. The user is allocated to a group in the case that the value of the user illustrating the network states is within the range of the group having the maximum and the minimum value.

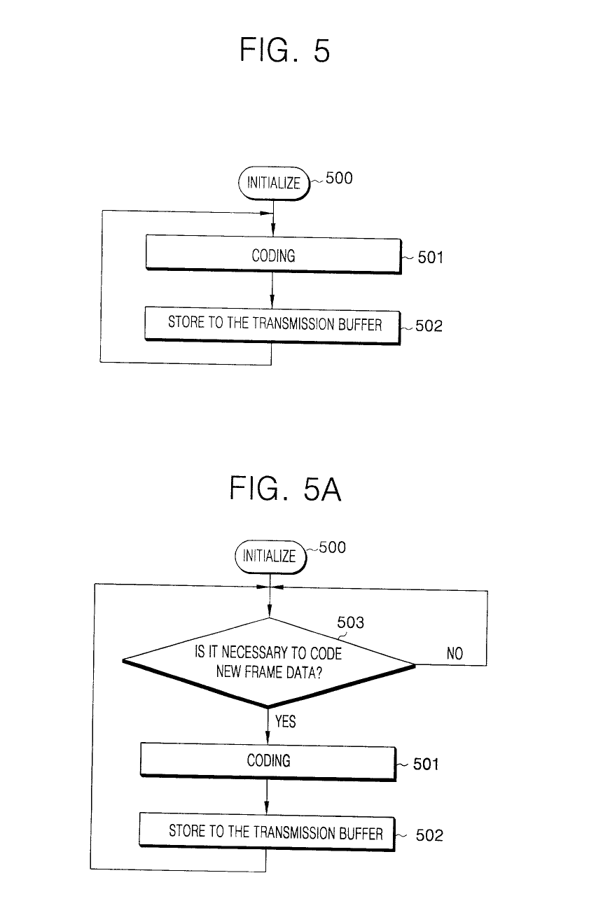

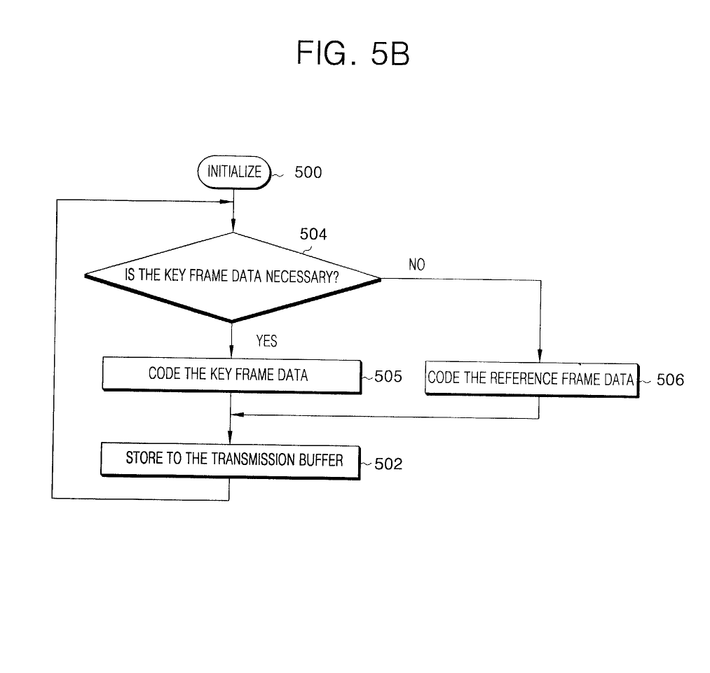

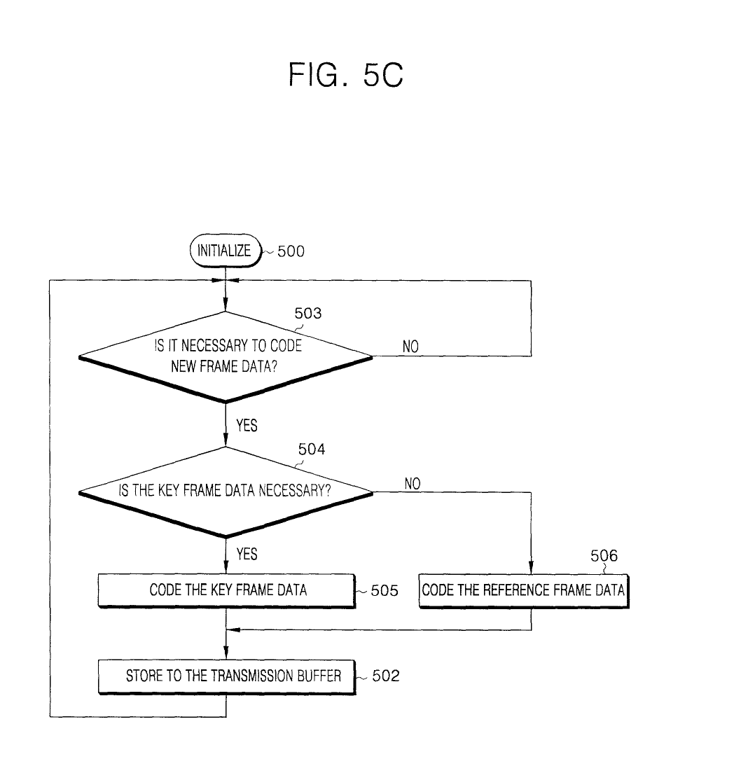

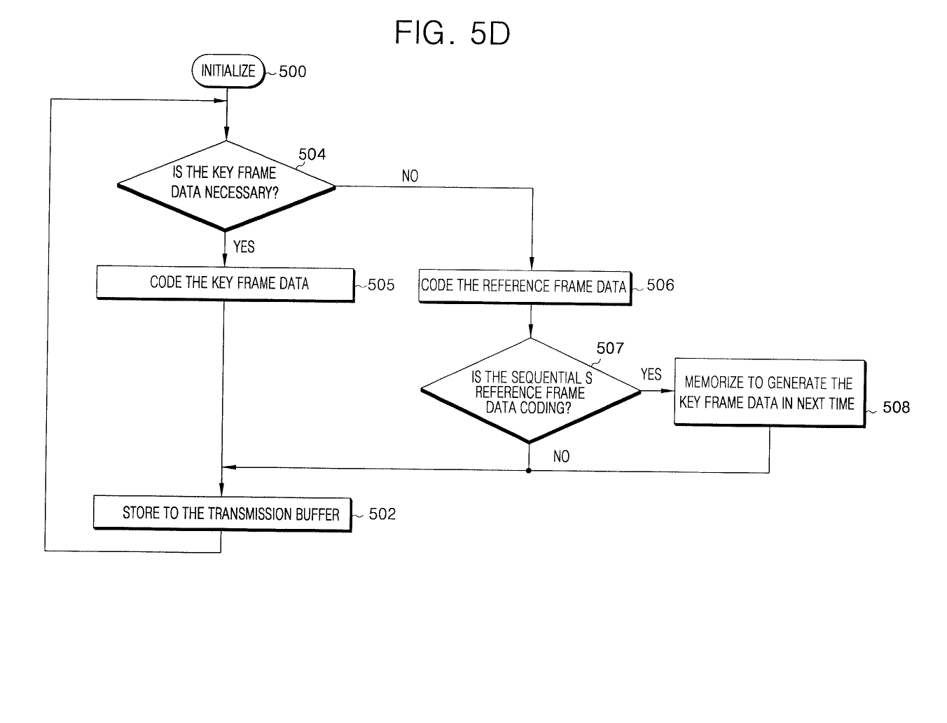

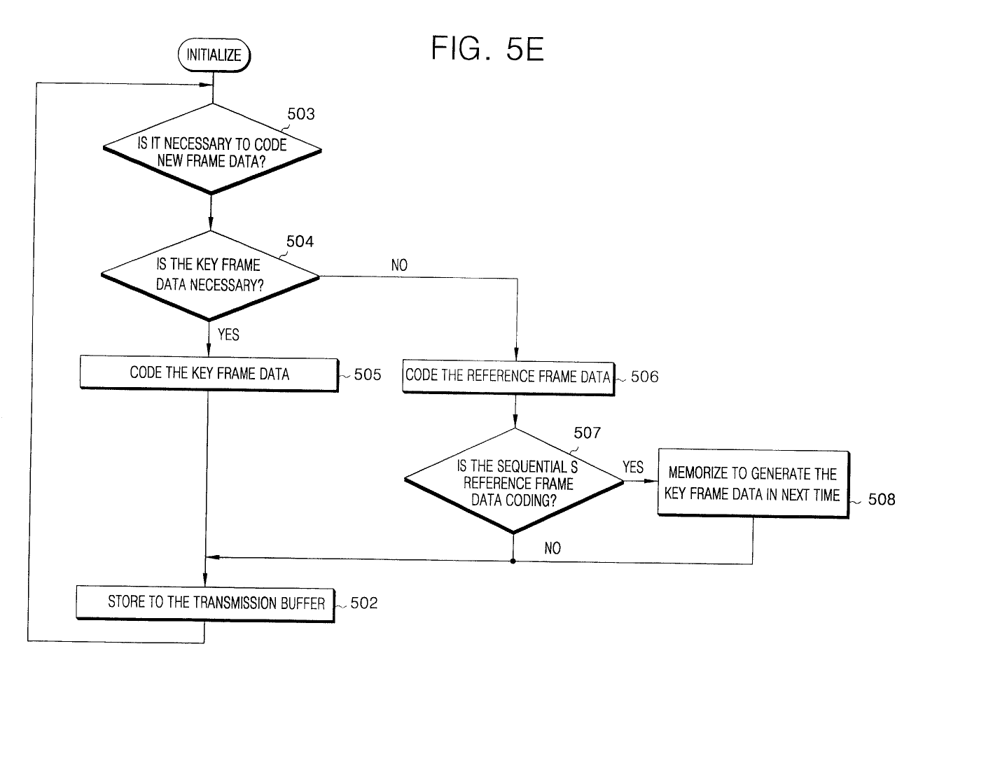

FIG. 5 is a flow chart of a coder for generating a frame data by coding the data of the preferred embodiment according to the present invention. FIG. 5a is a flow chart of the coder for deciding whether it is necessary to code new frame data or not, according to the preferred embodiment of the present invention. In more, FIG. 5b is a flow chart of the coder when the coder discriminately codes frame data into key frame data and reference frame data, according to the preferred embodiment of the present invention.

At first, the step (500) initializes the coder 31 in the coding process of the step (410). A step (501) codes the A/V data inputted through one channel or multi-channel to the frame data. The step 502 stores the coded frame data in the transmission buffer 32 and the above described processes are repeated to store another frame data to the transmission buffer 32.

In the case that the step (410) does not code the data excessively by applying Consideration 1 or Consideration 2, as illustrated in FIG. 5a, the step (503) decides whether it is necessary to code new data or not.

The step (503) decides whether it is necessary to encode new data or not. In the case that encoding new data is necessary and the coder 31 encodes all data not only to the key frame data but also to the reference frame data, as shown in FIG. 5b, the step (504) decides whether the key frame data is necessary or not. In next, the step (505) encodes the data to the key frame data, and the step (506) encodes the data to the reference frame data according to the decision of the step (504). The coded key frame data and reference frame data in the above step (505) and (506) is stored to the transmission buffer 302. At this time, whether the key frame data is necessary or not is determined according to how the above described key frame generation conditions 1˜5 is combined and applied.

FIG. 5c is a flow chart illustrating an example applying Consideration 1 or Consideration 2 in FIG. 5b. As illustrated in FIG. 5b, a step (504) decides whether the key frame is necessary or not, after the step (503) decides whether it is necessary to encode the new frame data or not. Following the decision of the above step (504), a step (505) encodes the data to the key frame data and a step (506) encodes the data to the reference frame data. The coded key frame data and reference frame data in the above step (505) and (506) is stored to the transmission buffer 302.

FIG. 5d is a flow chart illustrating an example for employing Condition 5 in FIG. 5b. The step (507) and (508) are performed after the step (506) encodes the reference frame data. The step (507) decides whether ‘s’ numbers of reference frame data are continuously encoded or not. The step (508) stores the coded reference frame data to transmission buffer 302 according to the decision of the step (507) or memorize to generate a key frame data in next time.

FIG. 5e is a flow chart illustrating an example for employing Condition 5 in FIG. 5c. At first, the step (503) decides whether it is necessary to encode new frame data or not. The following step (504) decides whether the key frame data is necessary or not. The step (505) encodes the key frame data according to the decision of the step (504). The step (506) encodes the reference frame data, and the step (507) decides whether ‘s’ numbers of reference frame data are encoded continuously while performing encoding the reference frame data. The step (508) stores the coded reference frame data to the transmission buffer 302 according to the decision about encoding in the step (507), or memorizes to generate the key frame data in next time.

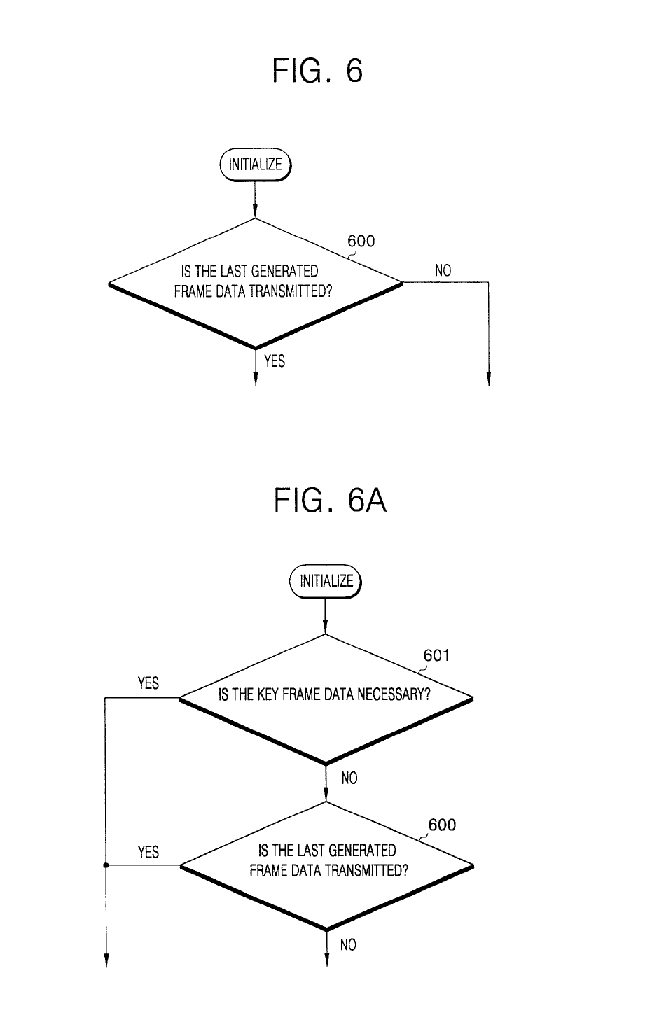

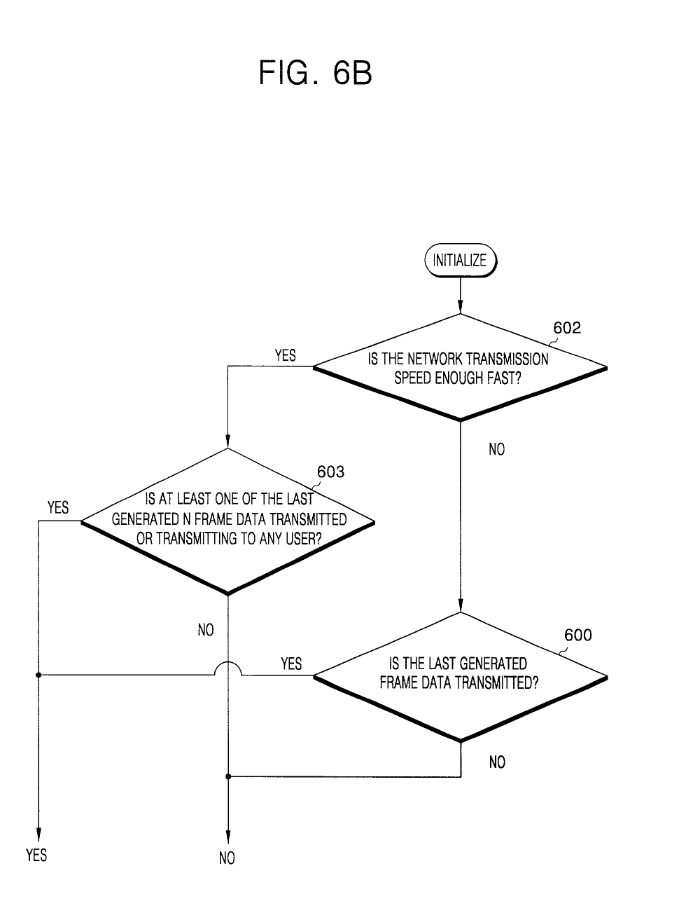

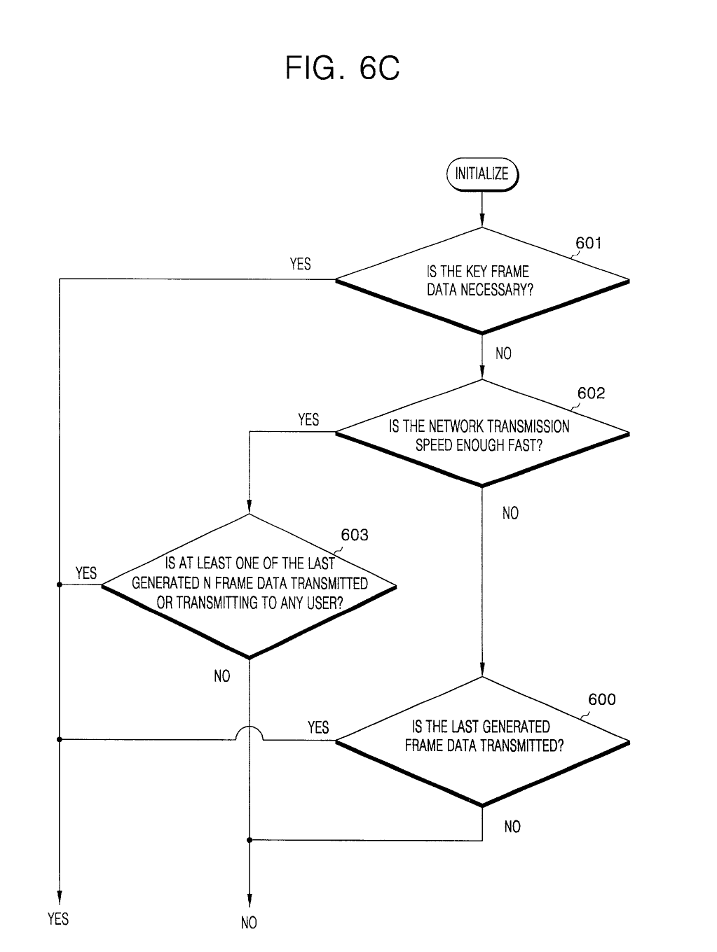

FIG. 6 is a detail flow chart for deciding whether it is necessary to code the new frame data or not, according to the preferred embodiment of the present invention. The step (503), deciding whether it is necessary to encode new frame data or not, comprises the step (600) that decides to whom the last generated frame data is transmitted.

FIG. 6a is a flow chart illustrating an example discriminately encoding the key frame data and the reference frame data in FIG. 6. FIG. 6a illustrates a step (601) and a step (600). When the inputted data is encoded into not only the key frame data but also the reference frame data, the step (601) decides whether it is necessary to encode the key frame data or not. The step (600) decides to whom the last generated frame data is transmitted.

FIG. 6b is a flow chart illustrating an example employing Condition 2 for deciding whether it is necessary to code the new frame data or not, according to the preferred embodiment of the present invention. At first, the step (602) decides whether the network states are good or not. The step (603) decides whether one of the ‘n’ numbers of the last generated frame data has already transmitted to the user or is being transmitted to the user or not. When one of the ‘n’ numbers of the last generated frame data has already transmitted to the user or is transmitting to the user, new frame data is encoded. When one of the ‘n’ numbers of the last generated frame data is not transmitted to the user and is not transmitting to the user, new frame data is not encoded.

FIG. 6c is a flow chart illustrating an example discriminately encoding the key frame data and the reference frame data of the preferred embodiment according to the present invention. When all data in FIG. 6b is encoded to not only the key frame data but also to the reference frame data, the events requesting the frame data includes the step (601) that decides whether it is necessary to encode new key frame data or not.

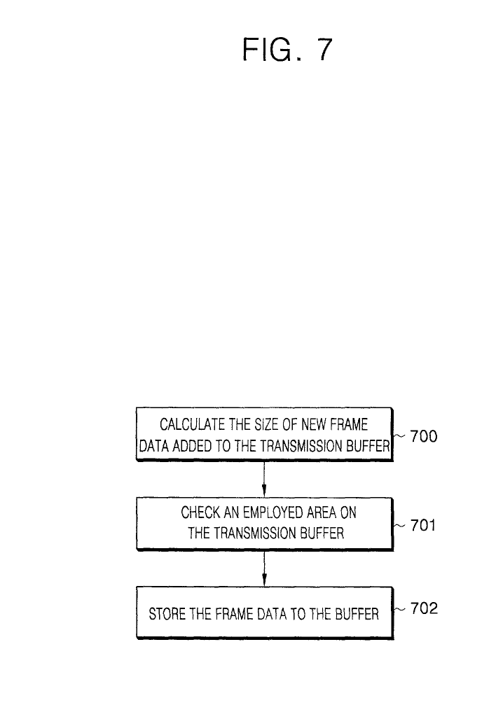

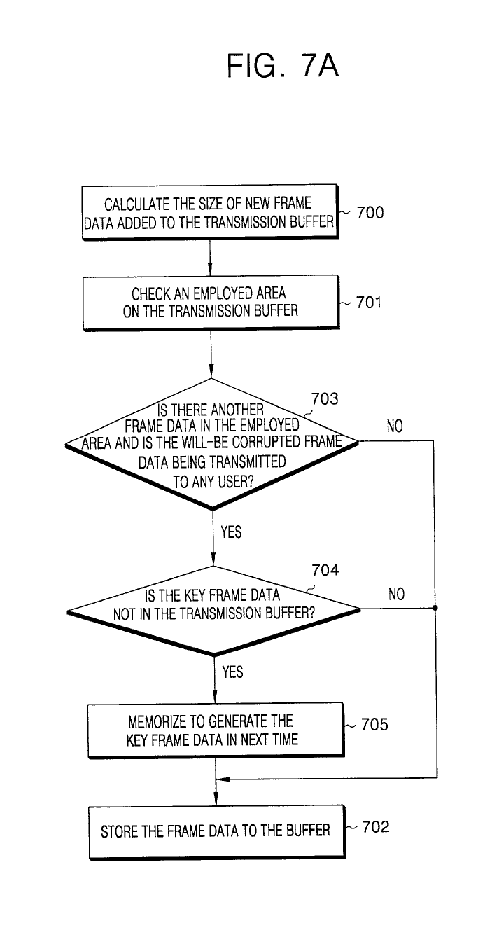

FIG. 7 is a detail flow chart for storing the new frame data to a transmission buffer of the preferred embodiment according to the present invention. At first, the step (700) calculates the size of the frame data stored to the transmission buffer. In next, the step (701) decides the area of the transmission buffer to store new frame data and the step (702) stores the frame data to the transmission buffer.

When the data is encoded to not only the key frame data, but also to the reference frame data, and the frame data is transmitted to the user through the network, it is necessary to copy the frame data transmitted from the transmission buffer to additional allocated data. If the frame data is not copied, then the area of the transmission buffer where the frame data is transmitted can be damaged by another frame data while transmitting the frame data. To avoid this, it is necessary to have a memory space for storing one frame data corresponding to each of the users. However, numerous users cause to use an excessive amount of memory.

FIG. 7a is a flow chart illustrating an example for storing frame data to the transmission buffer by employing Condition 4 of the preferred embodiment according to the present invention. The reference frame data, different from the key frame data, can not be decoded independently, but decoded using the other transmitted data.

Therefore, when additional memory is not employed to transmit the frame data to each of the users, the step (700) calculates the size of the frame data stored in the transmission buffer. In next, the step (701) decides the area of the transmission buffer to store new frame data, and the step (703) decides whether another frame data is in the employing area and is being transmitted to one of the users or not. When an area of the frame data transmitting to one of the users is re-employed, the information for the transmitting data to the user will be lost. Therefore, the transmitting data in next time should be the key frame data.

According to the above described statement, a step (704) decides whether key frame data are in the transmission buffer or not. When any key frame data is not in the transmission buffer, a step (705) memorizes to encode the key frame data in next time and a step (702) stores the frame data to the transmission buffer.

In the case that all data is encoded to the key frame data, another Consideration is not required because all data is the key frame data, even though additional memory for transmitting the frame data is not employed.

The procedure, for transmitting the coded data stored in the transmission buffer to each of the users connected to the network via the grouped user transmission controller, is that the transmission controller for each of the users receives the frame data from the transmission buffer sharing in common in a group, and transmits the frame data to the users through the network.

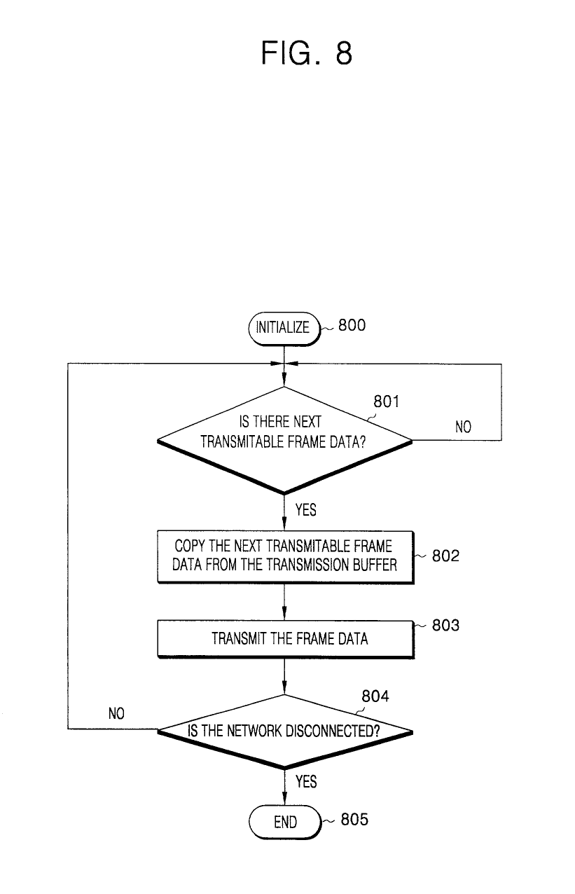

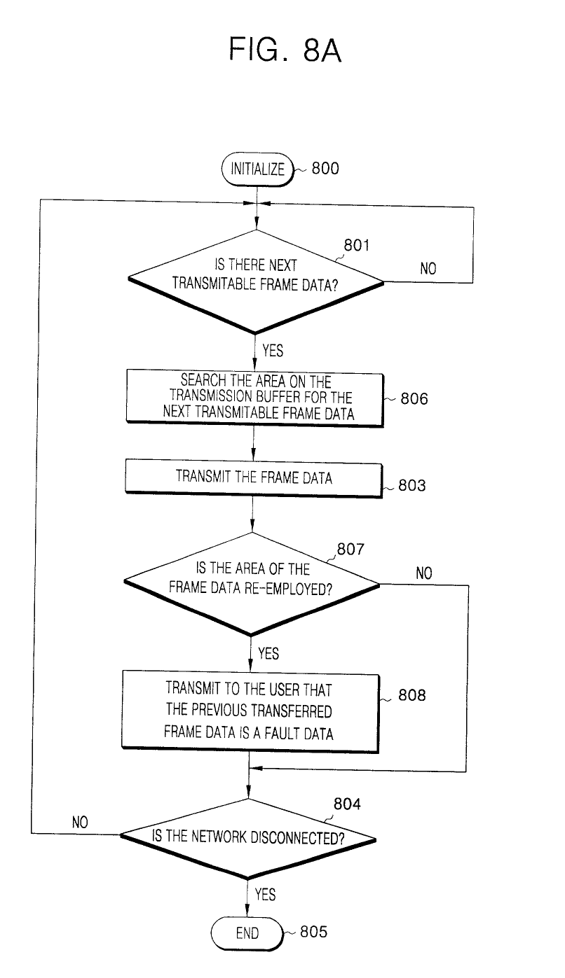

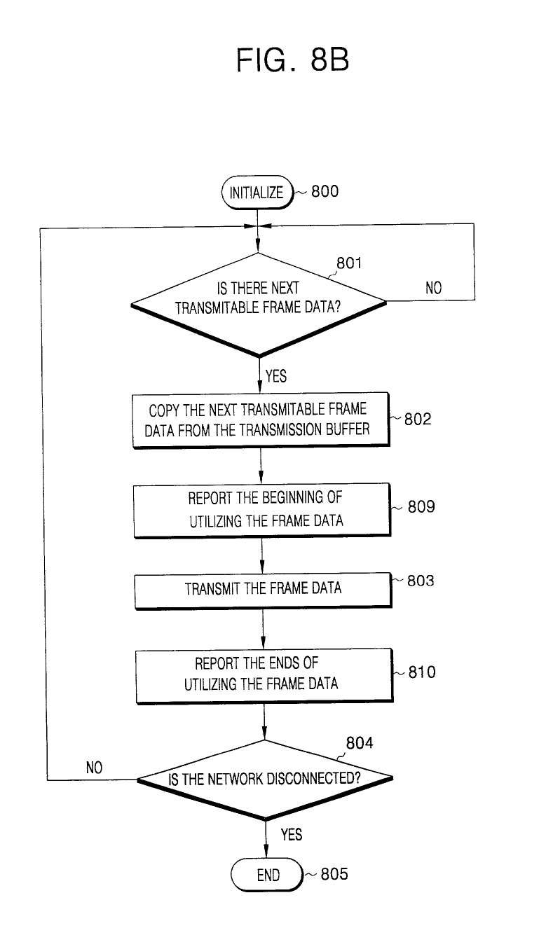

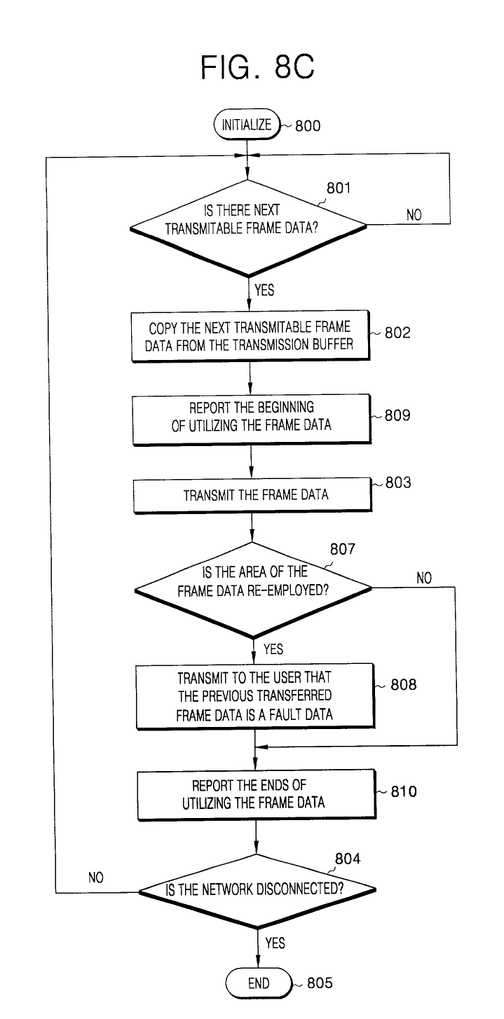

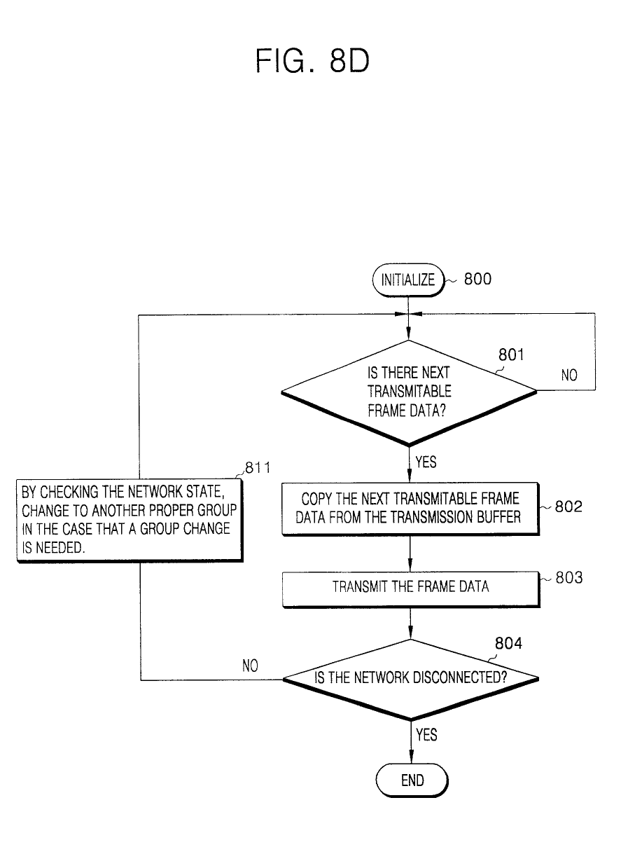

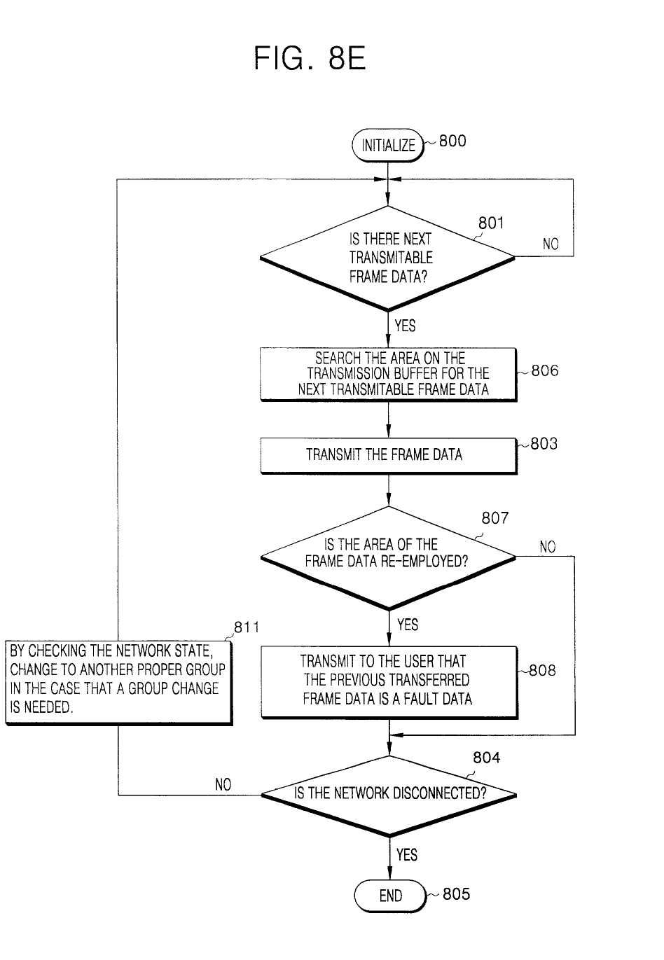

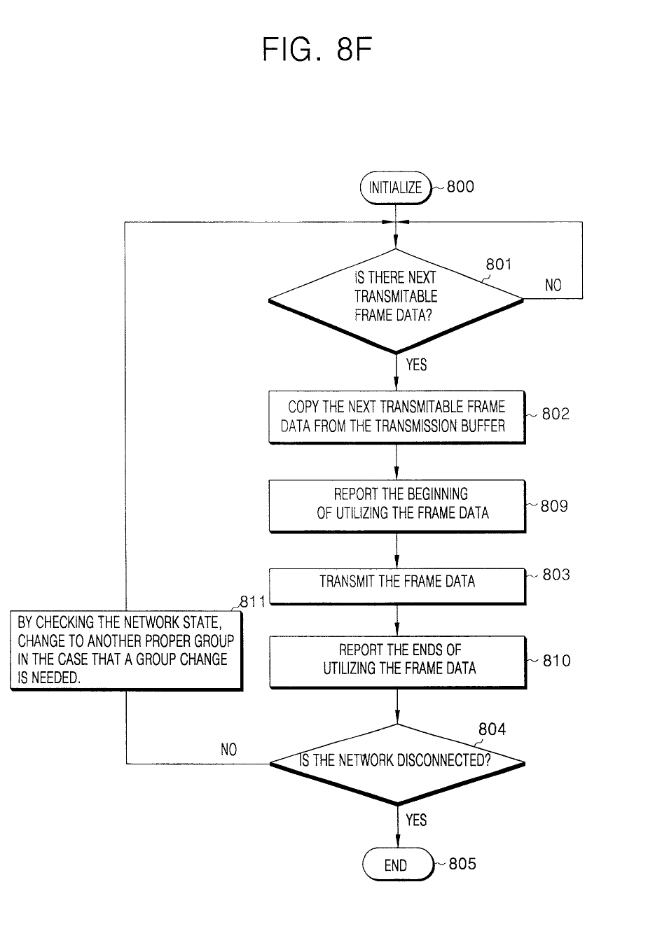

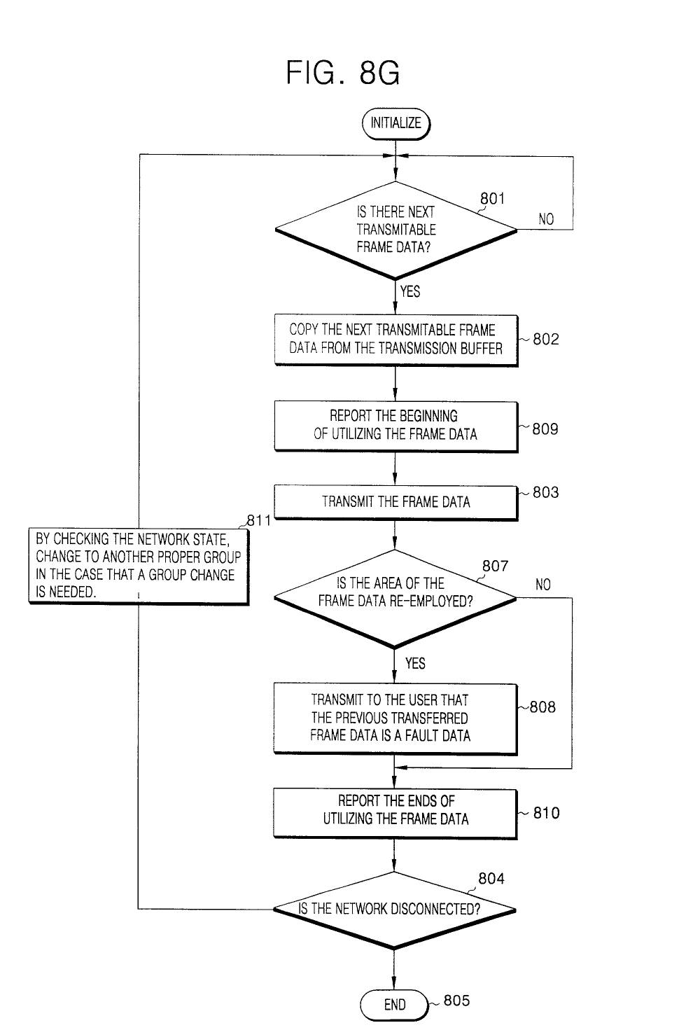

FIG. 8 is a flow chart illustrating a user transmission controller transmitting frame data to each of the users, according to the preferred embodiment of the present invention. When the users connect through the network, a step (800) initializes the user transmission controller. In more, a step (801) decides whether the next transmitable frame data is or not.

When there is the frame data transmitable to the users, a step (802) copies the frame data in the transmission buffer to additional memory. A step (803) transmits the copied data to the users, and a step (804) decides whether the network is connected after transmitting in present time or not. If the network is connected, the data is transmitted to the users by repeating the above procedure. If the network is disconnected, the user transmission controller is closed.

FIG. 8a is a flow chart illustrating an example of the user transmission controller employing Consideration 5 of the preferred embodiment according to the present invention. In other words, without having additional storing space for the frame data transmitting to each of the users in present time, utilizing the transmission buffer prepared for each of the groups reduces the device memory usage.

Therefore, in transmission buffer of FIG. 8, the frame data is not copied to the additional memory by applying the step (802). However, the step (806) checks the memory area only. After performing the step (803) for transmitting the frame data, the step (807) decides whether another frame data is re-employed to the frame data area while transmitting the frame data or not. If the frame data area is re-employed, the step (808) reports to the user that the previous transmitted data is a wrong data, and the step (804) decides whether the network is connected or not.

However, if the frame data area is not re-employed, the next frame data is continuously transmitted as checking whether the network is connected or not.

FIG. 8b is a flow chart illustrating an example of the user transmission controller employing Consideration 1 or Consideration 2 in FIG. 8. When the user connects to the network and the network states are good, the step (800) initializes the user transmission controllers. In more, the step (801) decides whether the next frame data transmittable to the user is or not.

When there is a frame data transmittable to the user, the step (802) copies the frame data in the transmission buffer to additional memory. Before using the frame data, the step (809) reports the beginning of the using the frame data to the device. In other words, the step(809) reports to the device that the frame data in the transmission buffer is used or is being used the frame data in present time. The step (810) report to the device after the usage of the frame data is completed, and the step (804) decides whether the network is connected or not.

FIG. 8c is a flow chart illustrating an example of the user transmission controller employing Consideration 1 or Consideration 2 in FIG. 8a additionally. In other words, as shown in FIG. 8a, without preparing any additional storing space for the transmitting frame data, less device memory is used by utilizing the transmission buffer prepared for each of the users. To apply Consideration 1 or Consideration 2, the step (809) reports the beginning of the usage to the device before using the transmission buffer for making the device to know that the frame data in the transmission buffer is used or is being using. In next, the step (803) transmits the frame data to the user and the step (810) reports the completion of the frame data usage.

FIG. 8d, FIG. 8e, FIG. 8f, FIG. 8g add a step (811) that changes automatically the present group for the user to any proper group by re-checking the present network states after transmitting one frame data to FIG. 8, FIG. 8a, FIG. 8b, FIG. 8c, respectively.

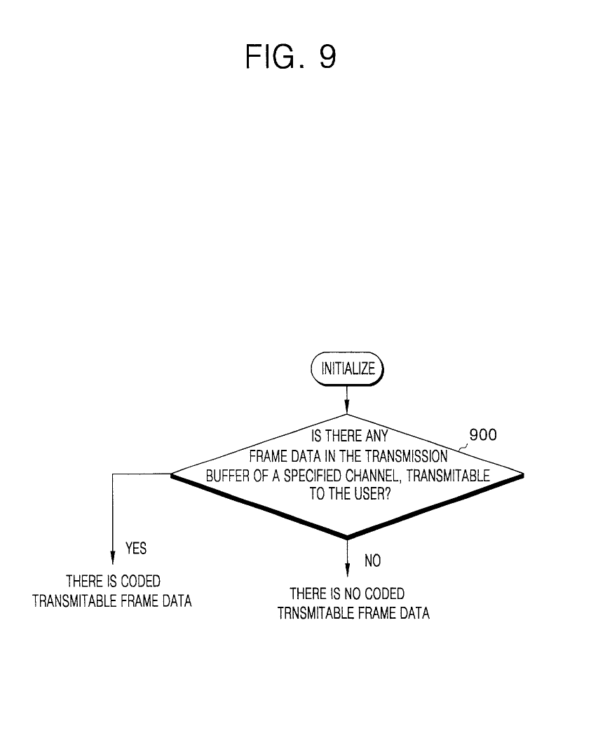

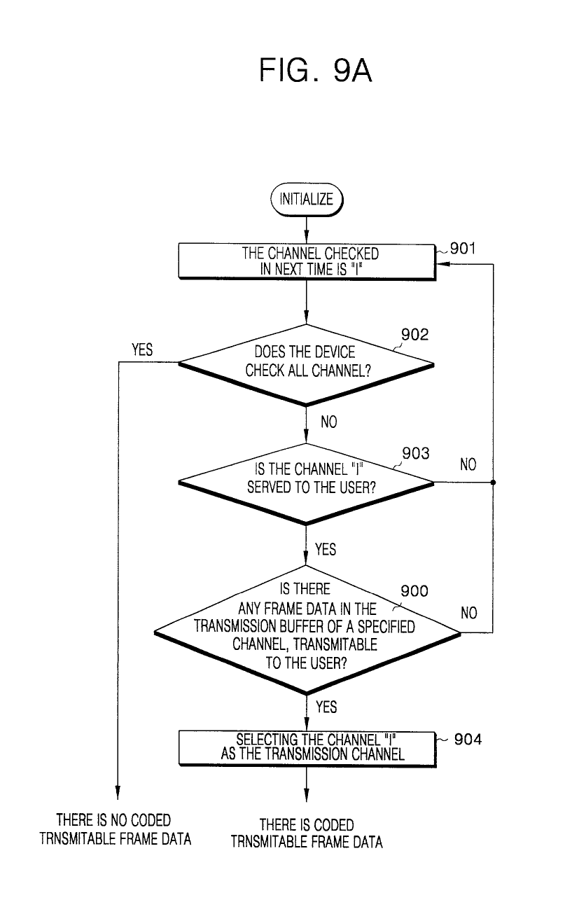

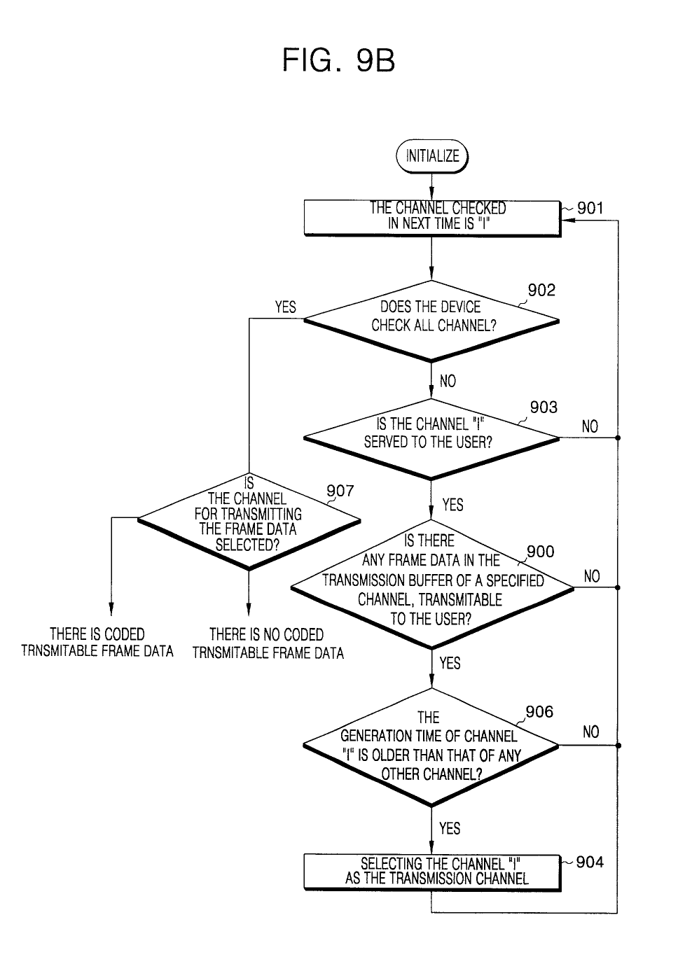

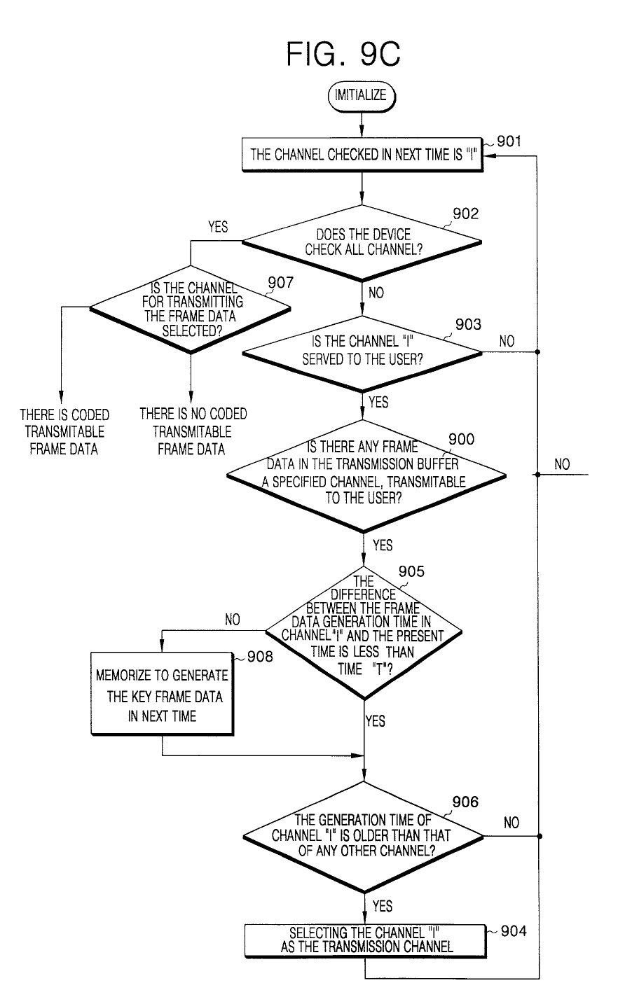

FIG. 9 is a detail flow chart for deciding whether the next transmittable frame data is in the user transmission buffer or not, according to the preferred embodiment of the present invention. A step (900) for deciding basically whether the next transmittable frame data is in the transmission buffer of the present channel or not, is performed instead of the step (801) for deciding whether the next transmittable frame data exists or not.

FIG. 9a is a flow chart illustrating an example employing multi-channels for deciding whether the next transmittable frame data is in the user transmission buffer or not, according to the preferred embodiment of the present invention. A step (901) basically selects channel ‘i’ as the next inquirable channel using the information of a reference of a previous transmitted channel or an inquired channel. A step (902) decides with the selected channel ‘i’ whether the device completes to check all channels or not. When the device completes to check all channels, then, there is no transmittable frame data.

However, when the device does not complete to check all channels, the step (903) decides whether the channel ‘i’ is being served to the user or not. When the channel ‘i’ is not currently served to the user, the device re-selects the inquirable channel ‘i’ to check the next channels. When the user utilizes the channel ‘i’, the step (900) decides whether the next frame data transmittable to the user is in the transmission buffer of the channel ‘i’ or not. When the next transmittable frame data is in the transmission buffer, the step (904) selects the channel ‘i’ as the transmission channel. In next, the frame data prepared in the channel ‘i’ is transmitted in next time.

FIG. 9b is a flow chart illustrating an example employing Consideration 3 for deciding whether the next frame data transmittable to the user exists or not, according to the preferred embodiment of the present invention. In the case of multi-channels, to fit the synchronism between the channels, the flow chart in FIG. 9b illustrates that the channel having the oldest generation time is transmitted at first. The step (901) selects the channel ‘i’ as the next channel using the information of the transmitted channel previously or the inquired channel. The step (902) decides whether the device completes to check all channels from the channel ‘i’. When the device completes to check all channels, the step (907) decides whether the device fixes the transmittable channel or not.

However, when the device does not complete to treat all channels, the step (903) decides whether the selected channel ‘i’ is served to the user or not. When the selected channel ‘i’ is not being currently served to the user, the step (901) checks the next channel.

On the contrary, the selected channel ‘i’ is being currently served to the user, the step (900) decides whether the next frame transmittable to the user is in the transmission buffer of the channel. When the transmittable frame data is not, the step (901) checks the next channel.

However, when the next transmittable frame data is in the transmission buffer, the step (906) decide whether the generation time of the channel ‘i’ is older than the generation time of another channels. The step (904) selects the channel ‘i’ as the next transmittable channel if the generation time of the channel ‘i’ is older than that of another channels. On the contrary, if the generation time of the channel ‘i’ is not older than that of another channels, the step (901) checks the next channel.

FIG. 9c is a flow chart illustrating an example employing Condition 2 for deciding whether the next frame data transmittable to the user exists or not, according to the preferred embodiment of the present invention. In other words, to fit synchronism between the channels in the case of the multi-channels, the device memorizes to generate new key frame data when the difference between the generation time of the generated frame data and the present time is more than a predetermined time T. In more, the device transmits the channel of the oldest generation time at first to maintain the synchronism between the channels more. FIG. 9c is a flow chart illustrating such an embodiment. The step (901) selects the channel ‘i’ as the next checkable channel using an information of the transmitted channel or the inquired channel. The step (902) decides whether the device completes to check all channels or not. When the device completes to treat all channels, the step (907) decides whether the transmittable channel is fixed or not.

However, when the device does not complete, the step (903) decides whether the selected channel ‘i’ is being currently served or not. When the channel ‘i’ is not being currently served to the user, the step (901) checks the next channel.

On the contrary, when the channel is being currently served to the user, the step (900) decides whether the next frame data transmittable to the user is in the transmission buffer of the channel. When the next transmittable frame data is not, the step (901) checks the next channel.

However, when the next transmittable frame data is, the step (905) decides whether the difference between the generation time to the frame data of the channel ‘i’ and the present time is less than a predetermined time T. When the difference between these times is not less than the time T, the step (908) memorizes to generate the key frame data in next time.

However, when the difference between these times is less than the time T, the step 906 decides whether the generation time of the channel ‘i’ is older than the generation time of another channels checked until now. When the generation time of the channel ‘i’ is older than that of another channels, the step (904) selects the channel ‘i’ as the next transmittable channel. When the generation time of the channel ‘i’ is not older than that of another channels, the step (901) checks the next channel.

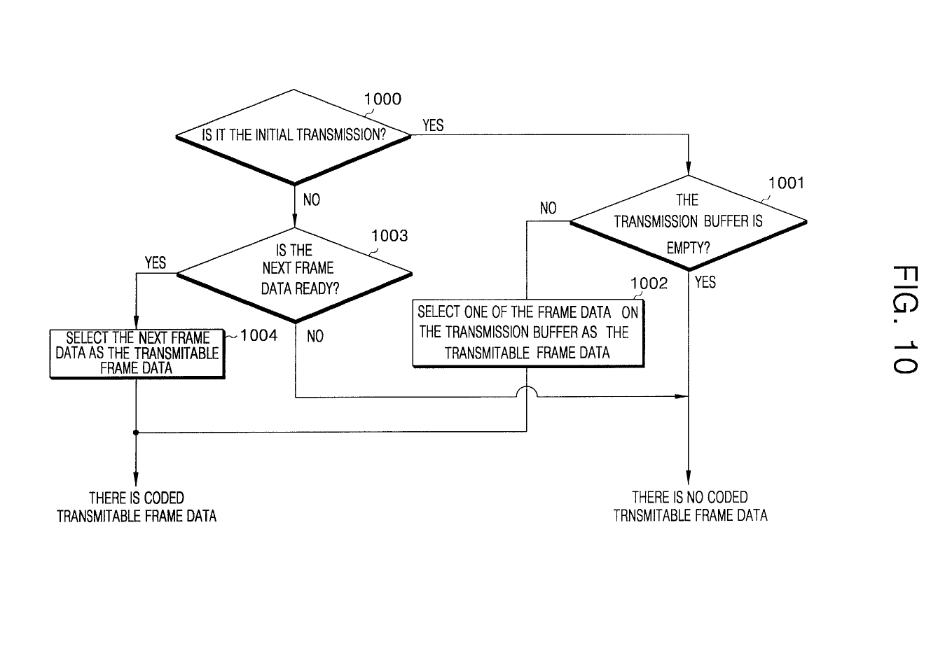

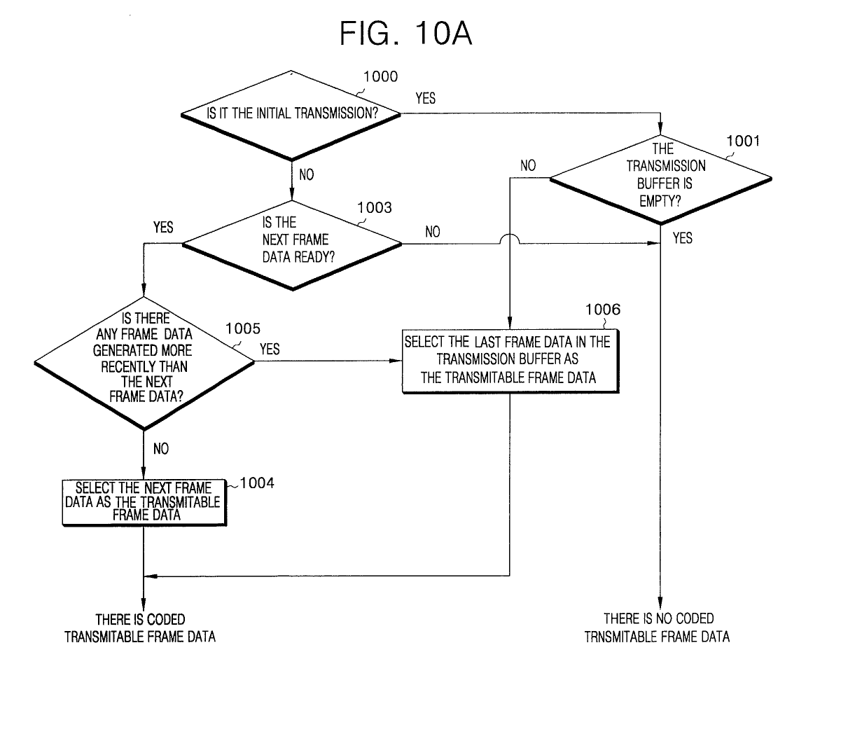

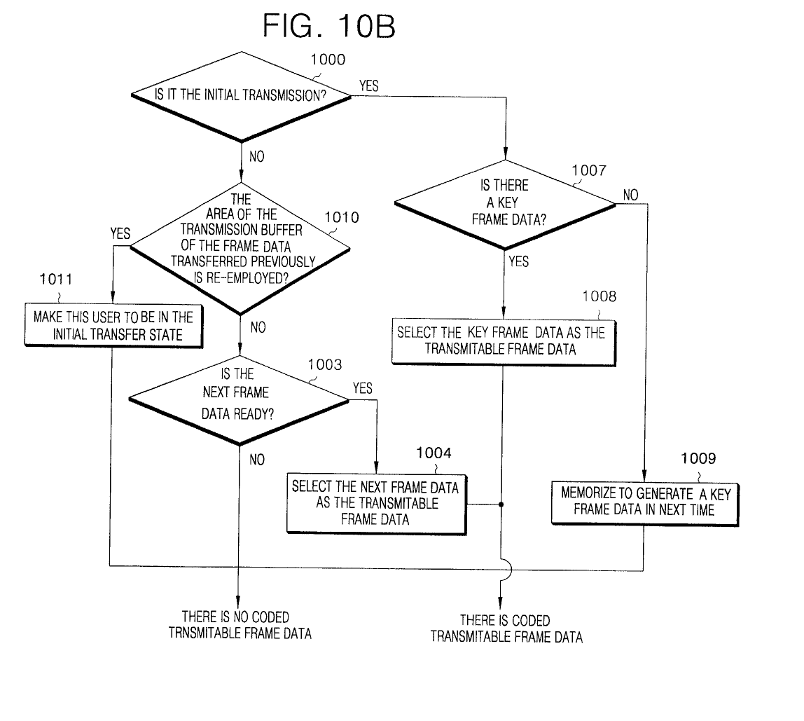

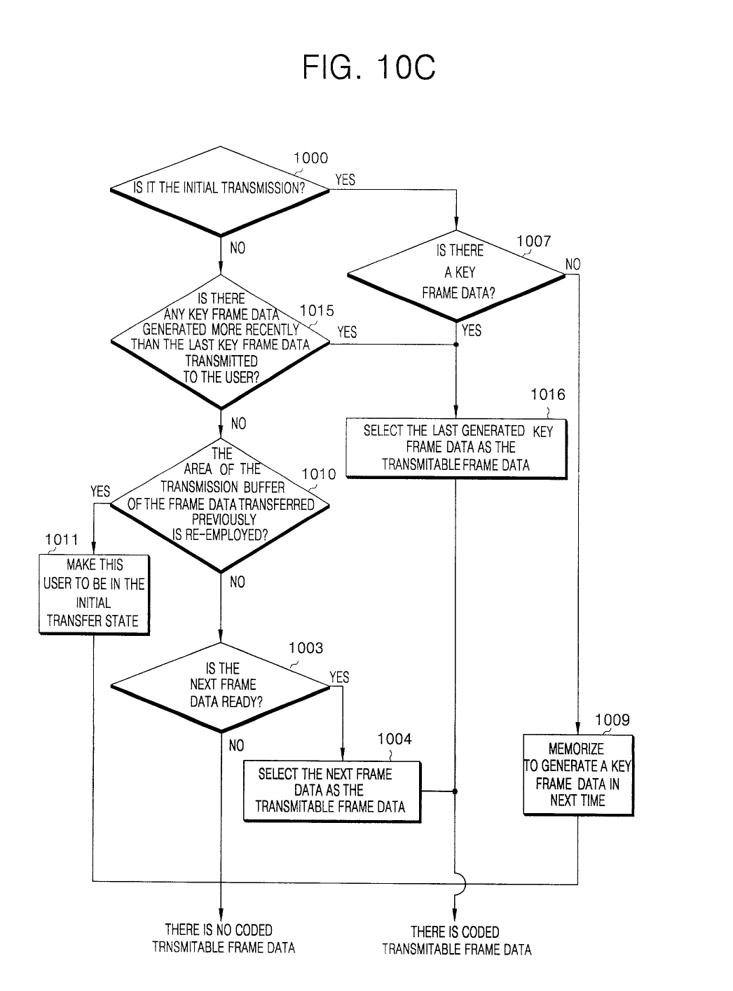

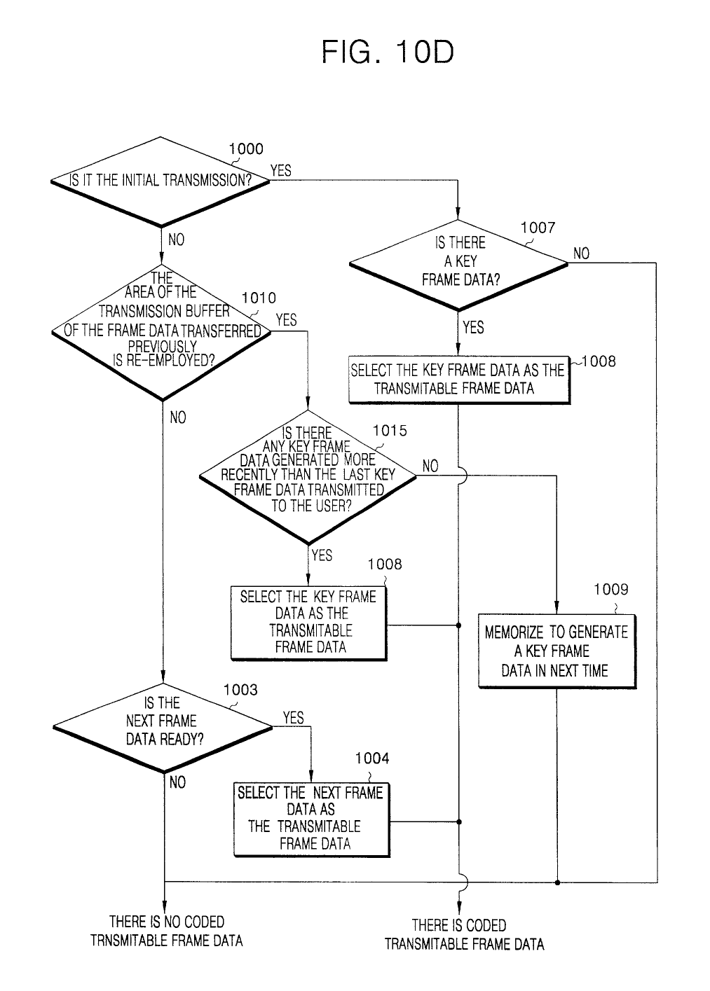

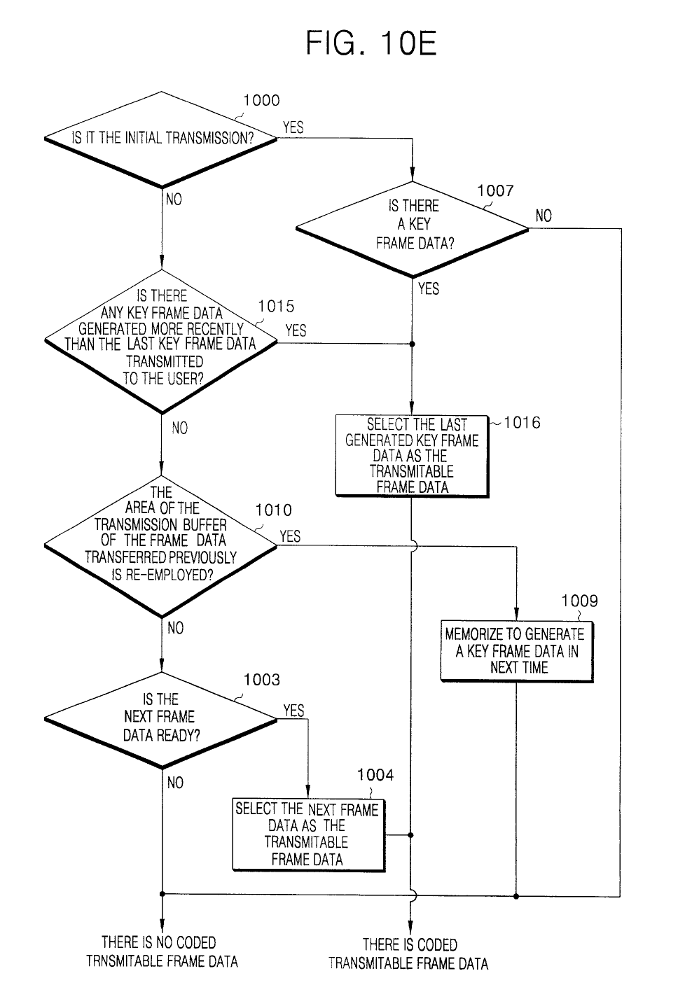

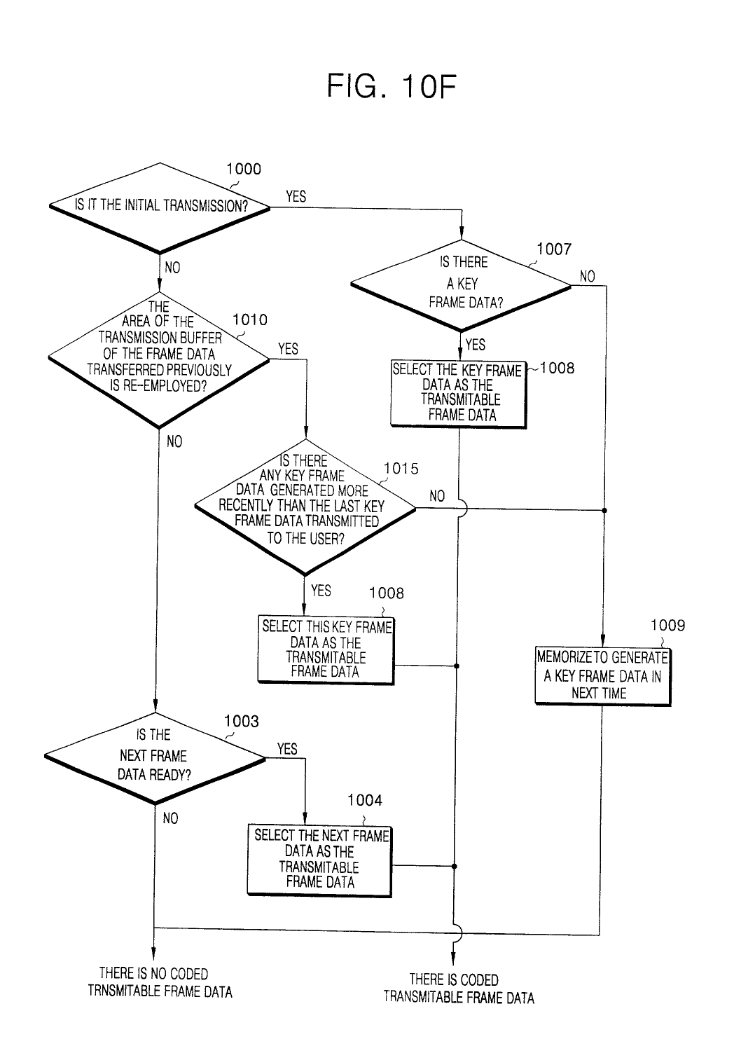

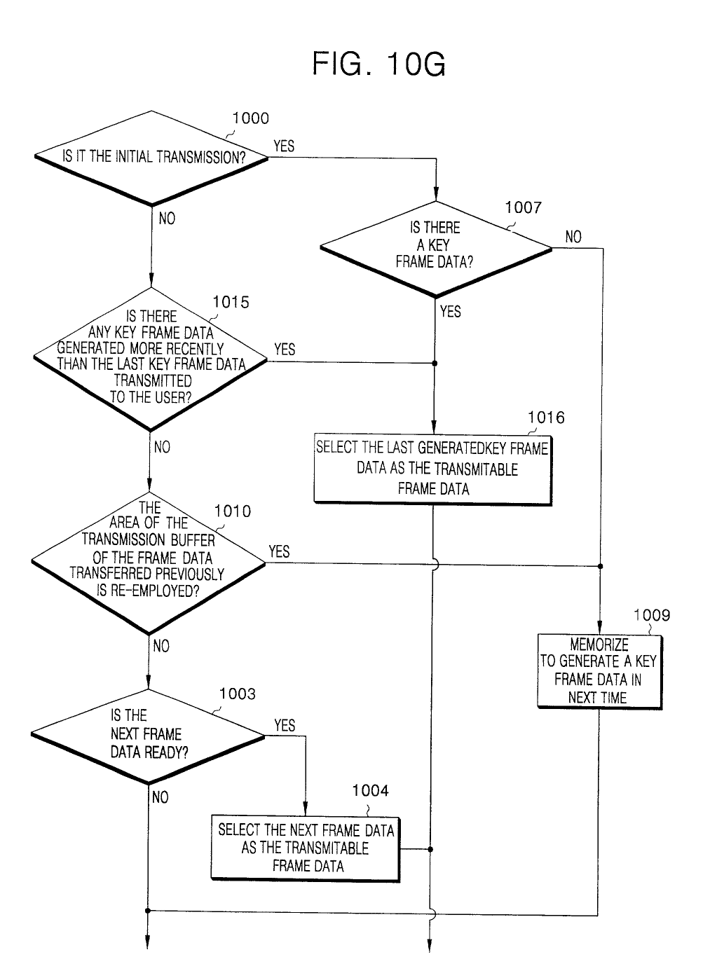

FIG. 10 is a detail flow chart of the step (900) for deciding whether the frame data transmittable to the user transmission buffer exists or not, when a channel and a user are determined, according to the preferred embodiment of the present invention. The step (1000) decides whether it is the initial transmission or not.

The initial transmission means that the frame data is transmitted from the channel at first after the user connects, or when the user changes the channel to new channel.

The step (1001) decides whether the transmission buffer is empty in the initial transmission or not. When the transmission buffer is empty, there is no next transmittable frame data. When the transmission buffer is not empty, the step (1002) selects any one of the frame data on the transmission buffer as a transmittable frame data.

Selecting the frame data can be performed in various ways. For example, the first generated frame data can be selected, and the last generated frame data can be selected.

However, in the case that it is not the initial transmission, a step (1003) decides by the frame data transmitted previously to the user whether the next transmittable frame data is prepared or not. If it does not, the next transmittable frame data is not. If it does, a step (1004) selects the next prepared frame data as a transmittable data.

FIG. 10a is a flow chart illustrating an example employing Consideration 6 in the step (900) for deciding whether the frame data transmittable to the user transmission buffer exists or not, according to the preferred embodiment of the present invention. In the case that several frame data are in the transmission buffer, the last frame data is selected as the next transmittable frame data. The step (1002) for selecting any one of the frame data on the transmission buffer as the transmittable frame data is changed to the step (1006) for selecting the last generated frame data on the transmission buffer as the next transmittable frame data. In next, the step (1005) decides whether the later generated frame data than the next frame data exists, when the next frame data is prepared, or not. If it does, the step (1006) selects the later generated frame data as the transmittable frame data on the transmission buffer. If it does not, the step (1004) selects the next frame data as the transmittable frame data.

FIG. 10b is a flow chart illustrating an example employing Condition 1 in step (900) for deciding whether the transmittable frame data is in the user transmission buffer or not, according to the preferred embodiment of the present invention. In the case that the key frame data and the reference frame data are coded discriminately, the step (1000) decides whether the transmittable frame data on the transmission buffer is the initial transmission or not. At this time, the step (1007) decides whether the key frame data is, when a predetermined channel is initialized, or not. In more, when there is no key frame data, the step (1009) memorizes to generate the key frame data.

When there is the key frame data, the step (1008) selects the key frame data as the next transmittable frame data.

However, if it is not the initial transmission, the step (1010) decides whether the area of the transmission buffer transmitted the previous frame data is re-employed or not. If it does, the step (1011) recognizes the user as the initial transmission states to transmit the key frame data in next time. Therefore, there is no transmittable frame data.

On the contrary, if it does not, the step (1003) decides whether the next frame data is prepared or not. When the next frame data is prepared, the step (1004) selects the next frame data as the transmittable frame data. In more, when the next frame data is not prepared, there is no transmittable frame data.

FIG. 10c is a flow chart illustrating an example employing Consideration 6 and Condition 1 in the step (900) for deciding whether the transmittable frame data is in the user transmission buffer or not, according to the preferred embodiment of the present invention. In case that it is not the initial transmission, and there are some key frame data, the step (1015) decides whether the later key frame data than the recent transmitted key frame data is generated or not. If it does, the step (1016) selects the later key frame data as the transmittable frame data.

FIG. 10d is a flow chart illustrating an example employing Condition 3 in the step (900) for deciding whether the transmittable frame data is in the user transmission buffer or not, according to the preferred embodiment of the present invention. In other words, when new frame data employs the area of the frame data transmitted to the user in the transmission buffer, and there is no newly generated key frame data, the key frame data is generated. Definitely, the procedure is as follows. The step (1000) decides whether it is the initial transmission or not. In the case of the initial transmission, the step (1007) decides whether there is key frame data or not. When there is no key frame data, there is no transmittable frame data. When there is the key frame data, the step (1008) selects any key frame data, as the next transmittable frame data.

When it is not the initial transmission, the step (1010) decides whether the area of the transmission buffer transmitted the frame data previously is re-employed or not. When the area of the transmission buffer transmitted the frame data previously is not re-employed, then the step (1003) decides whether the next frame data is prepared or not.

When the next frame data is prepared, the step (1004) selects the next frame data as the transmittable frame data. On the contrary, when the frame data is not prepared, there is no transmittable frame data.

If the area of the transmission buffer transmitted the frame data previously is re-employed, the step (1015) decides whether the later key frame data than the recent transmitted key frame data is generated or not, and the step (1018) selects the key frame data as the next transmittable frame data if the later key frame data is generated.

If the later key frame data is not generated, the step (1009) memorizes to generate the key frame data in next time, and there is no transmittable frame data in this case.

FIG. 10e is a flow chart illustrating an example employing Consideration 6 and Condition 3 for deciding whether the transmittable frame data is in the user transmission buffer or not, according to the preferred embodiment of the present invention. In the case that there is several transmittable frame data, the last generated frame data is selected as the next transmittable frame data. In more, when new frame data re-employs the area of the frame data transmitted to the user in the transmission buffer, and there is no newly generated key frame, the key frame data is generated.

At first, the step (1000) decides whether it is the initial transmission or not. If it is the initial transmission, the step (1007) decides whether there is the key frame data or not. Consequently, there is no transmittable frame data when there is no key frame data.

In the case that there is the key frame data, the step 1016 selects the last key frame data as the next transmittable frame data. Additionally, if it is not the initial transmission, the step 1015 decides whether the later key frame data than the key frame data transmitted recently to the user is generated or not. At this time, the step 1016 selects the later key frame data as the next transmittable frame data if the later frame data is generated.

When the later key frame data is not generated, the step 1010 decides whether the area of the transmission buffer transmitted the key frame data previously is re-employed or not. When the area is not re-employed, the step 1003 decides whether the next frame data is prepared or not. When the next frame data is prepared, the step 1004 selects the next frame data as the transmittable frame data.

On the contrary, when the next frame data is not prepared, there is no transmittable frame data. When the area of the transmission buffer used for the frame data previously transmitted is re-employed, the step 1009 memorizes to generate the key frame data in next time. In this case, there is no transmittable frame data.

FIG. 10f is a flow chart illustrating an example employing Condition 1 and Condition 3 for deciding whether the transmittable frame data is in the user transmission buffer or not, according to the preferred embodiment of the present invention. By employing Condition 1 to FIG. 10d additionally, if there is no key frame data in the initial transmission, the step 1009 memorizes to generate the key frame data in next coding time.

FIG. 10g is a flow chart illustrating an example employing Consideration 6, Condition 1 and Condition 3 together for deciding whether there is the transmittable frame data or not, according to the preferred embodiment of the present invention. By employing Condition 1 to FIG. 10e additionally, if there is no key frame data in the initial transmission, the step 1009 memorizes to generate the key frame data in the next coding time.

As described in the above statements, the present invention provides the user for one of the most optimized services without large loads to the server system, even though the number of the users is rapidly increased. It can be accomplished by grouping each of the users, according to the network states, to code the A/V data to generate proper size of the data. Therefore, it is not necessary that a coder and a transmission buffer is prepared for each user within the server respectively, wherein numerous users are connected to the server through the network to be provided with the A/V data of one or multi-channel.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A device for transmitting an audio and video (A/V) data in network, comprising:
a coder/transmission buffer coding and storing the A/V data, inputted from each of channels within a server providing the A/V data of one channel or multi channels for users connected to the network, to proper size fitting to the network states; and
a user transmission controller transmitting a coded storing data on the coder/transmission buffer to the user;
wherein the users are grouped with the user transmission controllers transmitting the coded data according to the network state of the group, while each of the user transmission controllers is allocated to each of the users connected to the server.

2. A device according to claim 1, wherein one group of the user transmission controllers comprises one coder and one transmission buffer.

3. A method for transmitting an audio and video (A/V) data in network, comprising:
a step of transmitting the A/V data of one channel or multi channel to the coder/transmission buffer;
a step of coding and storing the A/V data transmitted to the coder and the transmission buffer; and
a step of transmitting the coded storing data to each of the users connected to the network through the grouped user transmission controller.

4. A method according to claim 3, wherein the step of coding and storing the A/V data and the step of storing the coded data to the transmission buffer are performed in repeat.

5. A method according to claim 4, wherein the step of coding the A/V data encodes new data after checking the transmission buffer to avoid unnecessary encoding for the data.

6. A method according to claim 4, wherein the step of coding the A/V data comprises:
a step of deciding whether it is necessary to have the key frame data or not; and
a step of coding the data to the key frame data or to the reference frame data according to the decision;

7. A method according to claim 6, the method further comprising:
a step of checking whether ‘s’ numbers of the reference frame data are encoded continuously after encoding the reference frame data; and
a step of memorizing to generate the key frame data in the case that the ‘s’ numbers of the reference frame data are continuously encoded.

8. A method according to claim 4, wherein the step of coding the A/V data comprises:
a step of deciding whether it is necessary to encode new data or not;
a step of deciding whether the key frame is necessary when it is necessary to encode the new data; and
a step of coding the new data to the key frame data or to the reference frame data according to the decision.

9. A method according to claim 8, the method further comprising:
a step of checking whether ‘s’ numbers of the reference frame data are encoded continuously after encoding the reference frame data; and
a step of memorizing to generate the key frame data in the case that the ‘s’ numbers of the reference frame data are continuously encoded.

10. A method according to claim 8, wherein the step of deciding whether it is necessary to encode new data or not, is decided by whether the last generated frame data is transmitted or not.

11. A method according to claim 9, wherein the step of deciding whether it is necessary to encode new data or not, is decided by whether the last generated frame data is transmitted or not.

12. A method according to claim 7, wherein the step of deciding whether it is necessary to encode new data or not comprises:
a step of deciding whether it is necessary to encode the key frame data or not; and
a step of deciding whether the last generated frame data is transmitted or not.

13. A method according to claim 7, wherein the step of deciding whether it is necessary to encode new data or not comprises:
a step of deciding the network states; and
a step of deciding whether at least one of the last generated ‘n’ frame data is transmitted or being transmitted to one of the users or not in the case that the network state is good.

14. A method according to claim 7, wherein the step of deciding whether it is necessary to encode new data or not comprises:
a step of deciding whether the key frame data is necessary or not;
a step of deciding whether the network transmission speed is fast enough or not in the case that the key frame data is not necessary;
a step of deciding whether at least one of the last generated ‘n’ frame data is transmitted or being transmitted to one of the users or not in the case that the network transmission speed is fast enough; and
a step of deciding whether the last generated frame data is transmitted or not in the case that the network transmission speed is not fast.

15. A method according to claim 3, wherein the step of coding and storing the A/V data transmitted to the coder and the transmission buffer comprises:
a step of calculating a size of an added frame data to the transmission buffer;
a step of checking an employing area on the transmission buffer for the added frame data; and
a step of storing the frame data to the employing area on the transmission buffer.

16. A method according to claim 4, wherein the step of storing the frame data to the transmission buffer comprises:
a step of deciding whether there is another frame data in the employed area and this will-be corrupted frame data is being transmitted too any user or not;
a step of deciding whether the key frame data is in the transmission buffer or not in the case that the will-be corrupted frame data is being transmitted;
a step of memorizing to encode the key frame data in next time in the case that the key frame data is not; and
a step of storing the memorized key frame data to the transmission buffer.

17. A method according to claim 3, wherein the step of transmitting the coded storing data to each of the users connected to the network through the grouped user transmission controller comprises:
a step of initializing the user transmission controller;
a step of deciding whether next frame data transmittable to the users is or not;
a step of copying the frame data from the transmission buffer to additional memory in the case that the next frame data transmittable to the user is in the transmission buffer;
a step of transmitting the copied data to the user; and
a step of deciding whether the network is connected or not after transmitting the data.

18. A method according to claim 3, wherein the step of transmitting the coded storing data to each of the users connected to the network through the grouped user transmission controller comprises:
a step of initializing the user transmission controller;
a step of deciding whether the next frame data transmittable to the users is or not;
a step of checking the area of the transmission buffer of the next transmittable frame data instead of copying the frame data to an additional memory to reduce memory usage according to an increase of the users in the case that the frame data transmittable to the user is in the transmission buffer;
a step of transmitting the frame data on the area of the transmission buffer;
a step of deciding whether the frame data area is re-employed by another frame data while transmission;
a step of reporting to the user that the previous transmitted data is a wrong data, in the case that the frame data area is re-employed; and
a step of deciding whether the network is connected or not.

19. A method according to claim 15, wherein the step of transmitting the frame data comprises:
a step of reporting the beginning of the usage; and
a step of reporting the completion of the usage.

20. A method according to claim 16, wherein the step of transmitting the frame data to the users comprises:
a step of reporting the beginning of the usage; and
a step of reporting the completion of the usage.

21. A method according to claim 17, the method further comprising a step of automatically changing the present group to a proper group considering network states in the case that the network is connected.

22. A method according to claim 18, the method further comprising a step of automatically changing the present group to a proper group considering network states in the case that the network is connected.

23. A method according to claim 17, wherein the step of deciding whether the next frame data transmitable to the users is in the transmission buffer comprises:
a step of deciding whether the next frame data transmitable to the users is in the transmission buffer of a specified channel or not.

24. A method according to claim 18, wherein the step of deciding whether the next frame data transmitable to the users is in the transmission buffer comprises:
a step of deciding whether the next frame data transmitable to the users is in the transmission buffer of a specified channel or not.

25. A method according to claim 17, a step of deciding whether the next transmittable frame data is in the transmission buffer in the case of multi channel comprises:
a step of selecting the channel ‘i’ as the next checking channel with the information of the transmitted channel or the inquired channel basically;
a step of deciding whether the device checks all channels from the selected channel ‘i’ or not;
a step of deciding whether the channel ‘i’ is served to the user in the case that there is an unchecked channel or not; and
a step of selecting the channel ‘i’ by deciding whether the next frame data transmittable to the users is in the transmission buffer of the channel in the case that the channel is served to the users or not.

26. A method according to claim 18, a step of deciding whether the next transmittable frame data is in the transmission buffer in the case of multi channel comprises:
a step of selecting the channel ‘i’ as the next checking channel with the information of the transmitted channel or the inquired channel basically;
a step of deciding whether the device checks all channels from the selected channel ‘i’ or not;
a step of deciding whether the channel ‘i’ is served to the user in the case that there is an unchecked channel or not; and
a step of selecting the channel ‘i’ by deciding whether the next frame data transmittable to the users is in the transmission buffer of the channel in the case that the channel is served to the users or not.

27. A method according to claim 21, in the case that the oldest generated channel is transmitted at first by considering the synchronism between the channels, the method further comprising:
a step of deciding whether the transmittable channel is fixed after the device completes to check all channel or not; and
a step of deciding whether the generation time of the channel ‘i’ is older than the generation time of another channels or not after deciding whether the frame data transmittable to the users is in the transmission buffer of the channel.

28. A method according to claim 22, the method further comprising:
a step of deciding whether the difference between the generation time of the frame data and the present time is less than a predetermined time T to fit on synchronism between the channels more or not; and
a step of memorizing to generate the key frame data in next time in the case that the difference between them is less than the predetermined time T.

29. A method according to claim 17, wherein the step of deciding whether the next frame data transmittable to the users is in the transmission buffer or not comprises:
a step of deciding in detail whether it is the initial transmission or not in the case that the transmittable channel is fixed;
a step of deciding whether the transmission buffer is empty or not in the case of the initial transmission;
a step of selecting any one of the frame data on the transmission buffer as the transmittable frame data in the case that the transmission buffer is not empty, while there is no transmittable frame data in the case that the transmission buffer is empty;
a step of deciding whether the next transmittable frame data is prepared using the information of the frame data transmitted to the user previously in the case that it is not the initial transmission; and
a step of transmitting the next frame data in the case that the next transmittable frame data is prepared, while there is no the next transmittable frame data in the case that the next transmittable frame data is not prepared.

30. A method according to claim 18, wherein the step of deciding whether the next frame data transmittable to the users is in the transmission buffer or not comprises:
a step of deciding in detail whether it is the initial transmission or not in the case that the transmittable channel is fixed;
a step of deciding whether the transmission buffer is empty or not in the case of the initial transmission;
a step of selecting any one of the frame data on the transmission buffer as the transmittable frame data in the case that the transmission buffer is not empty, while there is no transmittable frame data in the case that the transmission buffer is empty;
a step of deciding whether the next transmittable frame data is prepared using the information of the frame data transmitted to the user previously in the case that it is not the initial transmission; and
a step of transmitting the next frame data in the case that the next transmittable frame data is prepared, while there is no the next transmittable frame data in the case that the next transmittable frame data is not prepared.

31. A method according to claim 17, wherein the step of deciding whether the next frame data transmittable to the user is in the transmission buffer or not comprises:
a step of checking whether the next transmittable frame data is in the transmission buffer using the information of the frame data previously transmitted to the user in the case that the key frame data and the reference frame data are not discriminately coded and the transmittable channel is fixed;
a step of checking there is a frame data generated later than the next transmitted frame data in the case that the next transmitted frame data is prepared;
a step selecting the last generated frame data as the next transmittable frame data in the case that there is frame data generated later than the next transmitted frame data;
a step of deciding whether a key frame data is generated later than the key frame data transmitted to the user recently in the case that the key frame data and the reference frame data is discriminately coded, or not; and
a step of selecting the last generated key frame data as the next frame data in the case that a more recently generated key frame data is.

32. A method according to claim 18, wherein the step of deciding whether the next frame data transmittable to the user is in the transmission buffer or not comprises:
a step of checking whether the next transmittable frame data is in the transmission buffer using the information of the frame data previously transmitted to the user in the case that the key frame data and the reference frame data are not discriminately coded and the transmittable channel is fixed;
a step of checking there is a frame data generated later than the next transmitted frame data in the case that the next transmitted frame data is prepared;
a step selecting the last generated frame data as the next transmittable frame data in the case that there is frame data generated later than the next transmitted frame data;
a step of deciding whether a key frame data is generated later than the key frame data transmitted to the user recently in the case that the key frame data and the reference frame data is discriminately coded, or not; and
a step of selecting the last generated key frame data as the next frame data in the case that a more recently generated key frame data is.

33. A method according to claim 17, wherein the step of deciding whether the next frame data transmittable to the users is in the transmission buffer or not comprises:
a step of deciding whether it is the initial transmission state for the user or not;
a step of deciding whether there is the key frame data in the case that it is the initial transmission; and
a step of memorizing to generate a key frame data in the case that there is no key frame data.

34. A method according to claim 18, wherein the step of deciding whether the next frame data transmittable to the users is in the transmission buffer or not comprises:
a step of deciding whether it is the initial transmission state for the user or not;
a step of deciding whether there is the key frame data in the case that it is the initial transmission; and
a step of memorizing to generate a key frame data in the case that there is no key frame data.

35. A method according to claim 17, wherein the step of deciding whether the next frame data transmittable to the user is in the transmission buffer or not comprises:
a step of deciding whether the area of the frame data transmitted previously in the transmission buffer is re-employed or not when the transmittable channel is fixed, the transmittable frame data on the transmission buffer is transmitted without copying the transmittable frame data from the transmission buffer to the additional memory, to reduce the memory usage according to the increase of the users;
a step of deciding whether a key frame data is generated later than the key frame data transmitted to the users previously in the case that the key frame data and the reference frame data are discriminately coded, or changing the state into the initial transmission state in the case that the key frame data and the reference frame data are not discriminately coded and the area of the transmission buffer is re-employed;
a step of memorizing to generate a key frame data by the coder in the case that there is no last generated key frame data recently; and
a step of determining the next transmittable frame data in the case that there is the last generated key frame data recently.

36. A method according to claim 18, wherein the step of deciding whether the next frame data transmittable to the user is in the transmission buffer or not comprises:
a step of deciding whether the area of the frame data transmitted previously in the transmission buffer is re-employed or not when the transmittable channel is fixed, the transmittable frame data on the transmission buffer is transmitted without copying the transmittable frame data from the transmission buffer to the additional memory, to reduce the memory usage according to the increase of the users;
a step of deciding whether a key frame data is generated later than the key frame data transmitted to the users previously in the case that the key frame data and the reference frame data are discriminately coded, or changing the state into the initial transmission state in the case that the key frame data and the reference frame data are not discriminately coded and the area of the transmission buffer is re-employed;
a step of memorizing to generate a key frame data by the coder in the case that there is no last generated key frame data recently; and
a step of determining the next transmittable frame data in the case that there is the last generated key frame data recently.
